(19) United States
(12) Patent Application Publication
(10) Pub. No.: US 2008/0057348 A1
(43) Pub. Date: Mar. 6, 2008

(54) Magnetic Recording Medium, Method Of Manufacturing Therefor, And Magnetic Read/Write Apparatus

(76) Inventors: Kenji Shimizu, Chiba-shi (JP); Akira Sakawaki, Ichihara-shi (JP); Kazuo Kobayashi, Chiba-shi (JP); Nguyen Tien Duong, Chiba-ken (JP); Hiroshi Sakai, Ichihara-shi (JP); Takashi Hikosaka, Tokyo (JP); Soichi Oikawa, Kawasaki-shi (JP); Tomoyuki Maeda, Kawasaki-shi (JP); Futoshi Nakamura, Ichikawa-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/541,905

(22) PCT Filed: Jan. 14, 2004
(86) PCT No.: PCT/JP04/00205

§ 371 Date: May 17, 2006

Related U.S. Application Data
(60) Provisional application No. 60/440,631, filed on Jan. 17, 2003.

(30) Foreign Application Priority Data
Jan. 14, 2003 (JP) 2003-6188
Jan. 14, 2003 (JP) 2003-6189
Apr. 7, 2003 (JP) 2003-103452
Apr. 7, 2003 (JP) 2003-103453

(51) Int. Cl. G11B 5/64; B05D 5/12; G11B 5/33

(52) U.S. Cl. 428/833; 427/131; 428/800

(57) ABSTRACT

A soft magnetic undercoat film, a first undercoat film, a second undercoat film, a perpendicular magnetic recording film, and a protective film are provided on a non-magnetic substrate, and the first undercoat film consists of Pt, Pd, or an alloy including at least one among these, and the second undercoat film consists of Ru or an Ru alloy.

### CROSS-REFERENCE TO RELATED APPLICATIONS

This application claims the benefit of Japanese Unexamined Patent Application, First Publication No. 2003-6188 filed Jan. 14, 2003; Japanese Unexamined Patent Application, First Publication No. 2003-6189 filed Jan. 14, 2003; Japanese Unexamined Patent Application, First Publication No. 2003-103452 filed Apr. 7, 2003; Japanese Unexamined Patent Application, First Publication No. 2003-103453 filed Apr. 7, 2003; and U.S. Provisional Application No. 60/440,631, the contents of which are incorporated herein by reference.

### TECHNICAL FIELD

The present invention relates to a magnetic recording medium, a method d manufacturing therefor, and a magnetic read/write apparatus using this magnetic recording medium.

### BACKGROUND ART

The recording density of the hard disk drive (HDD), which is one type of magnetic read/write apparatus, is presently increasing annually by 60% or more, and it is thought that this tendency will continue into the future. Thus, presently development of both magnetic recording heads and magnetic recording media that are suitable for high recording densities is progressing.

Presently, the magnetic recording media generally mounted in a commercially available magnetic read/write apparatus are in-plane magnetic recording media in which the easy magnetization axis in the magnetic film is oriented parallel to the substrate. Here, the easy magnetization axis denotes the axis along which magnetization is easily directed, and in the case of a Co alloy, denotes the c axis of Co having an hcp structure.

In an in-plane magnetic recording medium, when the recording density is increased, the volume per bit of the magnetic film becomes too small, and thus there is the possibility that the read/write characteristics will deteriorate due to the thermal fluctuation effects. In addition, when the recording density is increased, there is a tendency for the medium noise to increase due to the influence of the demagnetizing field at the boundary area between recording bits.

In contrast, what are termed a perpendicular magnetic recording medium, in which the easy magnetization axis in the magnetic film is oriented perpendicular to the substrate, can suppress the increase in noise even when the recording density has been increased because the influence of the demagnetizing field at the boundary area between recording bits is small and clear bit boundaries are formed. Furthermore, this perpendicular magnetic recording medium has become the focus of attention in recent years because the higher the recording density, the more magnetostatically stable it becomes, and the more its thermal fluctuation resistance is increased.

In recent years, the use of single pole heads, which a superior writing capacity on perpendicular magnetic recording media, are being investigated in response to the demand for further increasing the recording density of magnetic recording media. In order to use a single pole head effectively, providing a layer consisting of a soft magnetic material, called the backing layer, between the perpendicular magnetic recording film, which is the recording layer, and the substrate has been proposed in order to improve the efficiency of the of the flow of the magnetic flux between the single pole head and the magnetic recording medium.

However, the read/write characteristics become insufficient in a magnetic recording medium that simply provides a backing layer, and thus a magnetic read/write medium having superior recording read/write characteristics is needed.

Generally, a perpendicular read/write medium has a structure in which a backing layer (soft magnetic undercoat film), an undercoat film that orients the easy magnetization axis of the magnetic recording film perpendicular with respect to the substrate surface, a perpendicular magnetic recording film comprising a Co alloy, and a protective film are formed on a substrate.

To improve the read/write properties of the magnetic recording medium, of course a magnetic material having a low noise can be used on the perpendicular magnetic recording film, and several methods for improving the layered structure have been proposed, such as Japanese Patent Number 2669529, Japanese Unexamined Patent Application, First Publication No. Hei 08-180360, and Japanese Unexamined Patent Application, First Publication No. Hei 07-192244.

Japanese Patent No. 2669529 proposes a method in which the consistency of the lattice between the Ti alloy undercoat film and the hexagonal magnetic alloy film is increased and the c-axis orientation of the hexagonal magnetic alloy film is improved by providing a Ti undercoat film between a non-magnetic substrate and the hexagonal magnetic alloy film, and incorporating other elements in the Ti undercoat film.

However, when using the Ti alloy undercoat film, the exchange coupling in the magnetic alloy film becomes large, and at a result, further increasing the recording density becomes difficult because the medium noise increases.

Japanese Unexamined Patent Application, First Publication No. Hei 08-180360 proposes a method in which the c-axis orientation of the Co alloy perpendicular magnetic recording film is improved by forming an undercoat film consisting of Co and Ru between a non-magnetic substrate and the Co alloy perpendicular magnetic recording film.

However, the undercoat film consisting of Co and Ru decreases the ratio of the residual magnetization Mr to the saturation magnetization Ms, that is, Mr/Ms, of the perpendicular magnetic recording film provided thereon. As a result, further increasing the recording density becomes difficult because the thermal stability in the Co alloy magnetic film deteriorates.

Japanese Unexamined Patent Application, First Publication No. Hei 07-192244 proposes forming a Pt undercoat film between the substrate and the Co alloy perpendicular magnetic recording film.

However, when the perpendicular Co alloy magnetic recording film is formed on the Pt undercoat film, the mismatch in the crystal lattice sizes therebetween becomes large, and distortion occurs in the crystal structure of the perpendicular magnetic recording film. Thus, the exchange coupling between the magnetic particles in the perpendicular magnetic recording film becomes strong and the medium noise increases, and thereby further increasing the recording density becomes difficult.

### DISCLOSURE OF INVENTION

In consideration of the problems described above, it is an object of the present invention to provide a magnetic recording medium that can improve the read/write properties and allows reading and writing data at a high density, a manufacturing method for the same, and a magnetic read/write apparatus.

In order to obtain the objects described above, the present invention employs the following structure:

(1) A first invention for solving the problems described above is a magnetic recording medium that provides on a non-magnetic substrate at least a soft magnetic undercoat film, a first undercoat film that controls the orientation of the film directly above, a second undercoat film, a perpendicular magnetic recording film in which the easy magnetization axis is generally oriented perpendicular with respect to the substrate, and a protective film, and wherein the first undercoat film consists of Pt, Pd, or an alloy including at least one thereof, and the second undercoat film consists of Ru or an Ru alloy.

(2) A second invention for solving the problems described above is a magnetic recording medium in which, in the magnetic recording medium described in (1), the thickness of the first undercoat film is equal to or greater than 0.5 nm and equal to or less than 10 nm.

(3) A third invention for solving the problems described above is a magnetic recording medium in which, in the magnetic recording medium described in (1), the thickness of the second undercoat film is equal to or greater than 0.5 nm and equal to or less than 10 nm.

(4) A fourth invention for solving the problems described above is a magnetic recording medium in which, in the magnetic recording medium described in (1), the first undercoat film has a fcc structure.

(5) A fifth invention for solving the problems described above is a magnetic recording medium in which, in the magnetic recording medium described in (1), a seed film having an amorphous structure or a microcrystal structure is provided between the soft magnetic undercoat film and the first undercoat film.

(6) A sixth invention for solving the problems described above is a magnetic recording medium in which, in the magnetic recording medium described in (1), the first undercoat film includes C.

(7) A seventh invention for solving the problems described above is a magnetic recording medium in which, in the magnetic recording medium described in (1), the perpendicular magnetic recording film consists of a material that includes at least Co and Pt, and has a negative nucleation field (−Hn) equal to or greater than 0.

(8) An eighth invention for solving the problems described above is a magnetic recording medium in which, in the magnetic recording film recording medium described in (1), the first undercoat film has a granular structure consisting of Pt or Pd, and an oxide.

(9) A ninth invention for solving the problems described above is a magnetic recording medium in which, in the magnetic recording medium described in (8), the oxide is selected from SiO₂, Al₂O₃, Cr₂O₃, CoO, and Ta₂O₅.

(10) A tenth invention for solving the problems described above is a magnetic recording medium in which, in the magnetic recording medium described in (1), the second undercoat film has a granular structure consisting of Ru or an Ru alloy, and an oxide.

(11) An eleventh invention for solving the problems described above is a magnetic recording medium in which, in the magnetic recording medium described in (10), the oxide is selected from SiO₂, Al₂O₃, Cr₂O₃, CoO, and Ta₂O₅.

(12) A twelfth invention for solving the problems described above is a magnetic recording medium in which, in the magnetic recording medium described in (1), the perpendicular magnetic recording film consists of a material wherein at least one of SiO₂, Al₂O₃, ZrO₂, Cr₂O₃, and Ta₂O₅ are added to a CoPt alloy or a CoCrPt alloy.

(13) A thirteenth invention for solving the problems described above is a manufacturing method for a magnetic recording medium in which at least a soft magnetic undercoat film, a first undercoat film that controls the orientation of the film directly above, a second undercoat film, a perpendicular magnetic recording film in which the easy magnetization axis is generally oriented perpendicular to the substrate, and a protective film are formed in sequence on a non-magnetic substrate, the first undercoat film consists of Pt, Pd, or an alloy that comprises at least one among them, and the second undercoat film that consists of Ru or an Ru alloy.

(14) A fourteenth invention for solving the problems described above is a magnetic read/write apparatus providing a magnetic recording medium and a magnetic head that reads and writes data on this magnetic recording medium, wherein the magnetic recording medium provides on a non-magnetic substrate at least a soft magnetic undercoat film, a first undercoat film that controls the orientation of the film directly above, a second undercoat film, and a perpendicular magnetic recording film in which the easy magnetization axis is generally oriented perpendicular to the substrate, the first undercoat film consists of Pt, Pd, or an alloy that comprises at least one thereof, and the second undercoat film consists of Ru or and Ru alloy.

(15) A fifteenth invention for solving the problems described above is a magnetic recording medium providing on a non-magnetic substrate at least a soft magnetic undercoat film, an undercoat film that controls the orientation and the crystal diameter of the film directly above, a perpendicular magnetic recording film in which the easy magnetization axis is generally oriented perpendicular to the substrate, and a protective film, in which the undercoat film consists of an alloy that includes at least Pt and C or an alloy that includes at least Pd and C.

(16) A sixteenth invention for solving the problems described above is a magnetic recording medium in which, in the magnetic recording medium described in (15), the C content of the undercoat film is equal to or greater than 1 at % and equal to or less than 40 at %.

(17) A seventeenth invention for solving the problems described above is a magnetic recording medium in which, in the magnetic recording medium described in (15), the C content of the undercoat film is equal to or greater than 5 at % and equal to or less than 30 at %.

(18) An eighteenth invention for solving the problems described above is a magnetic recording medium in which, in the magnetic recording medium described in (15), the thickness of the undercoat film is equal to or greater than 0.5 nm and equal to or less than 15 nm.

(19) A nineteenth invention for solving the problems described above is a magnetic recording medium in which, in the magnetic recording medium described in (15), an intermediate film that includes at least one of Ru and Cu is provided between the undercoat film and the perpendicular magnetic recording film.

(20) A twentieth invention for solving the problems described above is a magnetic recording medium in which, in the magnetic recording medium described in (15), a seed film having an amorphous structure or a microcrystal structure is provided between the undercoat film and the perpendicular magnetic recording film.

(21) A twenty-first invention for solving the problems described above is a magnetic recording medium in which, in the magnetic recording medium described in (15), the undercoat film consists of any among a Pt—C alloy, Pt—Fe—C alloy, Pt—Ni—C alloy, Pt—Co≦C alloy, Pt—Cr—C alloy, Pd—C alloy, Pd—Fe—C alloy, Pd—Ni—C alloy, Pd-Co-C alloy, or a Pd—Cr—C alloy.

(22) A twenty-second invention for solving the problems described above is a magnetic recording medium in which, in the magnetic recording medium described in (15), the average diameter of the microcrystals in the undercoat film is equal to or greater than 5 nm or equal to or less then 12 nm.

(23) A twenty-third invention for solving the problems described above in which, in the magnetic recording medium described in (15), the perpendicular magnetic recording film consists of a material that includes at least Co and Pt, and having a negative nucleation field (−Hn) equal to or greater than 0.

(24) A twenty-fourth invention for solving the problems described above in which, in the magnetic recording medium described in (15), the perpendicular magnetic recording film consists of a material wherein at least one of SiO₂, Al₂O₃, ZrO₂, Cr₂O₃, and Ta₂O₅ are added to a CoPt alloy or a CoCrPt alloy are added.

(25) A twenty-fifth invention for solving the problems described above is a manufacturing method for a magnetic recording medium consisting of the steps of forming in sequence on a non-magnetic substrate at least a soft magnetic undercoat film, an undercoat film that controls the orientation and the crystal diameter of the film directly above, a perpendicular magnetic recording film in which the easy magnetization axis is generally oriented perpendicular to the substrate, and a protective film, and the undercoat film consists of an alloy including at least Pt and C or an alloy including at least Pd and C.

(26) A twenty-sixth invention for solving the problems described above is a manufacturing method for a magnetic recording medium in which, in the manufacturing method for the magnetic recording medium described in (25), the undercoat film is formed at a temperature between 150-400° C.

(27) A twenty-seventh invention for solving the problems described above is a magnetic read/write apparatus that provides a magnetic recording medium and a magnetic head that reads and writes information on a magnetic recording film, wherein the magnetic head is a single pole head, the magnetic recording medium provides on a non-magnetic substrate at least a soft magnetic undercoat film, an undercoat film that controls the orientation and the crystal diameter of the film directly above, a perpendicular magnetic recording film in which the easy magnetization axis is generally oriented perpendicular to the substrate, and a protective film, and the undercoat film consists of an alloy that includes at least Pt and C or an alloy that includes at least Pd and C.

Below, the negative nucleation field will be explained.

As shown in FIG. 2, in the history curve (MH curve), when ‘b’ denotes the intersection of the tangent at the point a where the magnetization becomes 0 in the process wherein the external magnetic field is decreased and the straight line denotes the saturation magnetization, the negative nucleation field (−Hn) can be expressed by the distance Oe from the Y-axis (M-axis) to the point b.

Note that the negative nucleation field (−Hn) has a positive value when the point b is in the region where the external magnetic field is negative (refer to FIG. 2), and conversely, has a negative value when the point b is in the region where the external magnetic field is positive (refer to FIG. 3).

The negative nucleation field (−Hn) can be measured by using a vibrating sample magnetometer or a Kerr effect measuring apparatus.

Note that 1 Oe=approximately 79 A/m.

In addition, the thickness of each of the films can be found by observing the medium cross-section using, for-example, a TEM (transmission electron microscope).

### BRIEF DESCRIPTION OF DRAWINGS

FIG. 1 is a cross-sectional drawing showing a first embodiment of the magnetic recording medium of the present invention.

FIG. 2 is a schematic diagram for explaining the negative nucleation field (−Hn).

FIG. 3 is a schematic diagram for explaining the negative nucleation field (−Hn).

FIG. 4 is a cross-sectional drawing showing a second embodiment of the magnetic recording medium of the present invention.

FIG. 5 is a cross-sectional drawing showing a third embodiment of the magnetic recording medium of the present invention.

FIG. 6 is a cross-sectional drawing showing a fourth embodiment of the magnetic recording medium of the present invention.

FIG. 7 is a graph showing the relationship between C content in the undercoat film and the read/write properties.

FIG. 8 is a cross-sectional drawing showing a fifth embodiment of the magnetic recording medium of the present invention.

FIG. 9 is a schematic structural drawing showing an Example of the magnetic read/write apparatus of the present invention.

FIG. 10 is a schematic structural drawing showing an Example of a magnetic head that allow use of the magnetic read/write apparatus shown in FIG. 9.

### BEST MODE FOR CARRYING OUT THE INVENTION

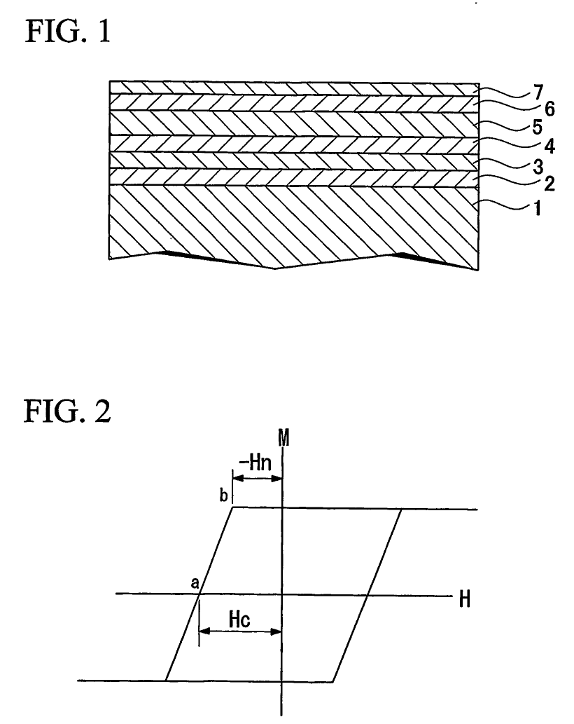

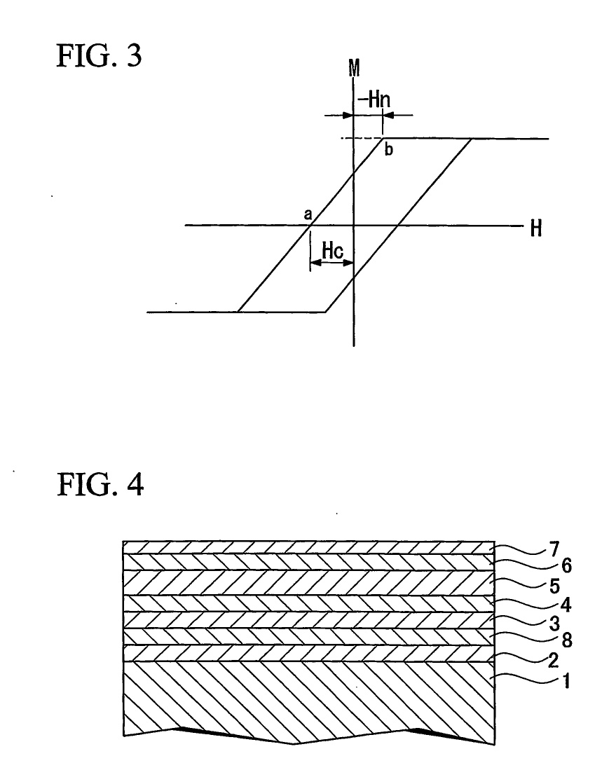

FIG. 1 shows a first embodiment of the magnetic recording medium of the present invention. The magnetic recording medium shown here provides on a non-magnetic substrate 1 a soft magnetic undercoat film 2, two undercoat films 3 and 4 that control the orientation of the film directly above, a perpendicular magnetic recording film 5 whose easy magnetization axis is generally oriented perpendicular to the substrate, a protective film 6, and a lubricating film 7.

Specifically, this magnetic recording medium is structured by forming in sequence on a non-magnetic substrate 1 the soft magnetic undercoat film 2 that consists of soft magnetic material, the first undercoat film 3, the second undercoat film 4, the perpendicular magnetic recording film S, the protective film 6, and the lubricating film 7.

A metal substrate consisting of a metal material such as aluminum or an aluminum alloy can be used as the non-magnetic substrate 1, or a non-magnetic substrate consisting of non-metallic material such as glass, ceramic, silicon, silicon carbide, or carbon can also be used.

An amorphous glass or a crystallized glass can be used as the glass substrate. A general-purpose soda-lime glass or aluminosilicate glass can be used as the amorphous glass, and a lithium-based crystallized glass can be used as the crystallized glass. A sintered body having as a main component, for example, a general-purpose aluminum oxide, aluminum nitride, silicon nitride, or the fiber-reinforced products thereof, can be used as the ceramic substrate.

The non-magnetic substrate 1 has a mean surface roughness Ra equal to or less than 2 nm (20 Å), and preferably equal to or less than 1 nm, which is desirable in terms of the application to high density recording because it is possible decrease the flying height of the magnetic head during reading and writing.

The non-magnetic substrate 1 has a minute waviness (Wa) equal to or less than 0.3 nm (more preferably, equal to or less than 0.25 nm), which is desirable in terms of the application to high density recording because it is possible to decrease the flying height of the magnetic head during reading and writing.

In addition, at least one among the chamfered edge portion and the side portion of the chamfer portion has a mean surface roughness equal to or less than 10 nm (more preferably, equal to or less than 9.5 nm), which is preferable in terms of the flying stability of the magnetic head.

The waviness (Wa) can be measured as the mean surface roughness in a measuring range of 80 μm using, for example, a surface roughness measuring apparatus P-12 (KLA-Tencor Co.).

The soft magnetic undercoat film 2 is provided in order to increase the perpendicular direction component of the magnetic flux generated from the magnetic head and in order to establish the direction of the magnetic flux of the perpendicular magnetic recording film 5, on which the data is recorded, more firmly in the perpendicular direction. This action becomes more significant in particular when a single pole head for perpendicular recording is used as the magnetic read/write head.

The soft magnetic undercoat film 2 consists of a soft magnetic material, and a material that includes Fe, Ni, or Co can be used for this material.

The following are Examples of this material: FeCo alloys (FeCo, FeCoB, and the like), FiNi alloys (FeNi, FeNiMo, FeNiCr, FeNiSi and the like), FeAl alloys (FeAl, FeAlSi, FeAlSiCr, FeAlSiTiRu, FeAlO and the like), FeCr alloys (FeCr, FeCrTi, FeCrCu and the like), FeTa alloys (FeTa, FeTaC, FeTaN and the like), FeMg alloys (FeMgO and the like), FeZr alloys (FeZrN and the like), FeC alloys, FeN alloys, FeSi alloys, FeP alloys, FeNb alloys, FeHf alloys, and FeB alloys, CoB alloys, CoP alloys, CoNi alloys (CoNi, CoNiB, CoNiP and the like), and FeCoNi alloys (FeCoNi, FeCoNiP, FeCoNiB and the like).

In addition, a material can be used that has a microcrystalline structure consisting of FeAlO, FeMgO, FeTaN, FeZrN or the like and that incorporates Fe at 60 at % or greater, or a granular structure in which fine crystal particles are dispersed in a matrix.

In addition to those cited above, it is also possible to use as the material for the soft magnetic undercoat film 2 a Co alloy that incorporates Co at 80 at % or greater and incorporates at least one or more selected from Zr, Nb, Ta, Cr, Mo or the like.

A CoZr alloy, CoZrNb alloy, CoZrTa alloy, CoZrCr alloy, CoZrMo alloy or the like can be suitably used as this material.

The coercive force Hc of the soft magnetic undercoat film 2 is preferably equal to or less than 100 Oe (and more preferably equal to or less than 20 Oe).

The coercive force Hc exceeding the above range is not preferable because the soft magnetic properties become insufficient and the read back waveform is not what is termed a rectangular wave, but becomes a distorted waveform.

The saturated magnetic flux density Bs of the soft magnetic undercoat film 2 is preferably equal to or greater than 0.6 T (more preferably, equal to or greater than 1 T). The Bs falling below this range is not preferable because the read back waveform is not what is termed a rectangular wave, but becomes a distorted waveform.

The product of the saturated magnetic flux density Bs and the thickness t of the soft magnetic undercoat film 2, Bs·t, is preferably equal to or greater than 40 T·nm (more preferably, equal to or greater than 60 T·nm). The product Bs·t falling below this range is not preferable because the read back waveform becomes a distorted waveform, and the OW properties (overwrite properties) deteriorate.

Sputtering methods, plating methods and the like can be used as the formation method of the soft magnetic undercoat film 2.

The soft magnetic undercoat film 2 can be have a form such that the material that forms it is partially or completely oxidized at the surface (the surface on the undercoat film 3 side).

Specifically, in the region of a predetermined depth from the surface of the soft magnetic undercoat film 2, it is possible that the material that forms the soft magnetic undercoat film 2 is locally oxidized or that this region consists of an oxide of this material.

The undercoat film 3 controls the orientation and crystal diameter of the second undercoat film 4 provided directly above and the perpendicular magnetic recording film 5.

The material that is used in the first undercoat film 3 is Pt, Pd, or an alloy including at least one thereof. Specifically, Pt, Pd, a Pt alloy, Pd alloy, or PtPd alloy can be used.

By using Pt, Pd, or an alloy including at least one thereof in the first undercoat film 3, the orientation of the second undercoat film 4 and the perpendicular magnetic recording film 5 provided on the first undercoat film 3 can be made advantageous.

With the object of making the crystal particles of the first undercoat film 3 microcrystalline, in the first undercoat film 3 it is preferable to use a Pt alloy in which the Pt has another element added or a Pd alloy in which the Pd has another element added.

B, C, P, Si, Al, Cr, Co, Ta, W, Pr, Nd, Sm and the like are preferable additive elements.

Among these, adding C is desirable. By incorporating C into the first undercoat film 3, the crystallinity of the second undercoat film 4 and the perpendicular magnetic recording film 5 can be made advantageous.

In addition, it is possible to use an alloy material having the additional elements given above in an alloy that includes Pt and Pd (PtPd alloy).

It is particular preferable that the first undercoat film 3 consists of any among a Pt—C alloy, Pt—Fe—C alloy, Pt—Ni—C alloy, Pt—Co—C alloy, Pt—Cr—C alloy, Pd—C alloy, Pd—Fe—C alloy, Pd—Ni—C alloy, Pd—Co—C alloy, Pd—Cr—C alloy, or Pt—Pd—C alloy.

The thickness of the first undercoat film 3 is preferably equal to or greater than 0.5 nm and equal to or less than 10 nm (in particular, 1-7 nm). When the thickness of the first undercoat film 3 is within this range, the perpendicular orientation of the perpendicular magnetic recording film S is particularly high and the distance between the magnetic head and the soft magnetic undercoat film 2 during reading and writing can be decreased. Thereby, there is no decrease in the resolution of the read signal and thus it is possible to improve the read/write properties.

When the thickness falls below this range, the perpendicular orientation of the perpendicular magnetic recording film 5 decreases, and the read/write properties and the thermal stability deteriorate.

In addition, when this thickness exceeds this range, the crystal particles become coarse and the distance between the magnetic head and the soft magnetic undercoat film 2 during reading and writing becomes large. As a consequence, the resolution of the read back signal and the read back output decrease.

The first undercoat film 3 preferably has a fcc structure. When the first undercoat film 3 has a fcc structure, the orientation of the second undercoat film 4 provided directly above and/or the perpendicular magnetic recording film 5 is favorable, and it is possible to make the crystal particles microcrystalline. The state of the crystal can be confirmed, for example, by X-ray diffraction or TEM (transmission electron microscopy).

The first undercoat film 3 can have a granular structure consisting of Pt and an oxide. In addition, it can have a granular structure consisting of Pd and an oxide.

SiO₂, Al₂O₃, Cr₂O₃, CoO, or Ta₂O₅ can be used as the oxide.

The average diameter of the crystal particles of the first undercoat film 3 is preferably equal to or greater than 5 nm and equal to or less than 12 nm. The average diameter can be found by observing the crystal particles of the first undercoat film 3 using TEM (transmission electron microscopy) and processing the observed image.

The surface profile of the first undercoat film 3 influences the surface profile of the perpendicular magnetic recording film 5 and the protective film 6, and thus in order to make the surface irregularities of the magnetic recording medium small and reduce the magnetic head flying height during reading and writing, preferably the mean surface roughness Ra of the first undercoat film 3 is equal to or less than 2 nm.

Because the mean surface roughness Ra is equal to or less than 2 nm, the surface irregularities in the magnetic recording medium can be made small, the magnetic head flying height during reading and writing can be made sufficiently low, and thus the recording density can be increased.

When forming the first undercoat film 3, with the object of making the crystal particles of the perpendicular magnetic recording film 5 microcrystalline, a process gas that includes oxygen or nitrogen can be used as the film developing gas. For example, in the case that the first undercoat film 3 is formed by using a sputtering method, preferably a gas that is a mixture consisting of oxygen mixed into argon at a volume of approximately 0.05 to 10% (preferably, 0.1 to 3%) or a gas that is a mixture consisting of nitrogen mixed into argon at a volume of approximately 0.01 to 20% (preferably, 0.02 to 5% ) is used.

The second undercoat film 4 is for preventing distortion in the crystal structure of the perpendicular magnetic recording film 5 that occur due to the difference in the crystal lattice size between the first undercoat film 3 and the perpendicular magnetic recording film 5 and for decreasing the exchange coupling of the magnetic particles (crystal particles) of the perpendicular magnetic recording film 5.

Ru or an Ru alloy are materials that can be used in the second undercoat film 4.

By using Ru or an Ru alloy in the second undercoat film 4, it is possible to improve the read/write properties.

With the object of decreasing both the crystal lattice size of the second undercoat film 4 and the exchange coupling in the perpendicular magnetic recording film 5, an Ru alloy having another element added to the Ru is preferably used in the second undercoat film 4.

B, C, P, Ta, W, Mo and the like are preferable additive elements.

Preferably the thickness of the second undercoat film 4 is equal to or greater than 0.5 nm and equal to or less than 10 nm (particularly, 1 to 6 nm). When the thickness of the second undercoat film 4 is within this range, the effects of the second undercoat film 4 (preventing distortion in the crystal structure of the perpendicular magnetic recording film 5 and decreasing the exchange coupling of magnetic particles) is increased and the distance between the magnetic head and the soft magnetic undercoat film 2 during reading and writing can be made small. Thereby, it is possible to improve the read/write properties without decreasing the resolution of the read back signal.

When this thickness falls below this range, the effects of the second undercoat film 4 decrease and the read/write properties deteriorate. In addition, when the thickness greatly exceeds this range, the crystal particles become coarse and the distance between the magnetic head and the soft magnetic undercoat film 2 during reading and writing increases. Thereby, the resolution of the read back signal and the read back output decrease.

The thickness of the second undercoat film 4 can be a value that exceeds 10 nm (for example, equal to or greater than 15 nm).

Preferably, the second undercoat film 4 has a hcp structure. The crystal structure can be confirmed by using, for example, X-ray diffraction or transmission electron microscopy (TEM).

The second undercoat film 4 can have a granular structure consisting of Ru and an oxide. SiO₂, Al₂O₃, Cr₂O₃, CoO, or Ta₂O₅ can be used as the oxide.

Preferably, the average diameter of the crystal particles of the second undercoat film 4 is equal to or greater than 5 nm and equal to or less than 12 nm. This average diameter can be found, for example, by observing the crystal particles of the second undercoat film 4 using TEM (transmission electron microscopy) and processing the observed image.

The easy magnetization axis of the perpendicular magnetic recording film 5 is oriented generally in the direction perpendicular to the substrate, and the perpendicular magnetic recording film S preferably consists of a material that includes at least Co and Pt.

For example, it is possible to use a CoPt alloy or a CoCrPt alloy. In addition, it is possible to use a material that has at least one of SiO₂, Al₂O₃, ZrO₂, Cr₂O₃, and Ta₂O₅ added to the CoPt alloy or the CoCrPt alloy.

In particular, preferably a CoCrPt alloy or a material having an oxide such as SiO₂, Al₂O₃, ZrO₂, or Cr₂O₃ added to the CoCrPt alloy is used.

In the case that a CoCrPt alloy that does not have an oxide added is used, preferably, the Cr content is equal to or greater than 14 at % and equal to or less than 24 at % (preferably, equal to or greater than 15 at % and equal to or less than 22 at % ), and the Pt content is equal to or greater than 14 at % and equal to or less than 24 at % (preferably, equal to or greater than 15 at % and equal to or less than 20 at % ).

The Cr content falling below this range is not preferable because below this range the exchange coupling between magnetic particles becomes large, which in turn results in the magnetic cluster diameter becoming large and the noise increasing. In addition, the Cr content exceeding this range is not preferable because above this range the coercive force and the ratio of the residual magnetization (Mr) and the saturation magnetization (Ms), that is, Mr/Ms, are reduced.

The Pt content falling below this range is not preferable because the effect of improving the read/write properties becomes insufficient, and at the same time, the ratio between the residual magnetization (Mr) and the saturation magnetization (Ms), that is, Mr/Ms, is reduced and the thermal stability deteriorates. In addition, the Pt content exceeding this range is not preferable because the noise increases.

In the case that a material having an oxide added to CoCrPt is used, the total Cr and oxide content is preferably equal to or greater than 12 at % and equal to or less than 22 at % (more preferably, equal to or greater than 14 at % and equal to or less than 20 at % ), and the Pt content is equal to or greater than 13 at % and equal to or less than 20 at % (more preferably, equal to or greater than 14 at % and equal to or less than 20 at % ).

The total Cr and oxide content falling below this range is not preferable because below this range the exchange coupling between magnetic particles becomes large, which in turn results in the magnetic cluster diameter becoming large and the noise increasing. In addition, the total Cr and oxide content exceeding this range is not preferable because above this range the coercive force and the ratio of the residual magnetization (Mr) and the saturation magnetization (Ms), that is, Mr/Ms, are reduced.

The Pt content falling below this range is not preferable because the effect of improving the read/write properties becomes insufficient, and at the same time, the ratio between the residual magnetization (Mr) and the saturation magnetization (Ms), that is, the Mr/Ms, is reduced and the thermal stability deteriorates. In addition, the Pt content exceeding this range is not preferable because the noise increases.

Note that “the easy magnetization axis is oriented generally in the direction perpendicular to the substrate” means that the coercive force Hc(P) in the perpendicular direction and the coercive force Hc(L) in the in-plane direction are such that Hc(P) >Hc(L).

The perpendicular magnetic recording film 5 can have a one-layer structure comprising a CoCrPt material or the like, or may have a two or more layer structure comprising different components.

The thickness of the perpendicular magnetic recording film 5 is preferably 7 to 30 nm (more preferably, 10 to 25 nm). When the perpendicular magnetic recording film 5 is equal to or greater than 7 nm, a sufficient magnetic flux can be obtained, the output during read back does not decrease, and it is possible to prevent the confirmation of the output waveform from becoming difficult due to the noise component. Thereby, a magnetic read/write apparatus that can be applied to an increased recording density can be obtained.

In addition, the thickness of the perpendicular magnetic recording film 5 is preferably equal to or less than 30 nm because it is thereby possible to suppress the increasing coarseness of the magnetic particles in the perpendicular magnetic recording film 5 and there is no concern that the read/write properties will deteriorate due to an increase in noise.

The coercive force of the perpendicular magnetic recording film 5 is preferably equal to or greater than 3000 Oe. The coercive force being less than 3000 Oe is not preferable because the necessary resolution for high recording density cannot be obtained, and in addition, the thermal stability deteriorates.

The ratio of the residual magnetization (Ms) saturation magnetization (Ms), that is, Mr/Ms, of the perpendicular magnetic recording film 5 is preferably equal to or greater than 0.9. The Mr/Ms being less than 0.9 is not preferable because the thermal stability deteriorates.

The negative nucleation field (−Hn) of the perpendicular magnetic recording film 5 is preferably equal to or greater than 0. The negative nucleation field (−Hn) being less than 0 is not preferable because the thermal stability deteriorates.

The average diameter of the crystal particles of the perpendicular magnetic recording film 5 is preferably equal to or greater than 5 nm and equal to or less than 12 nm. The average diameter can be found by observing the crystal particles of the perpendicular magnetic recording film 5 using TEM (transmission electron microscopy) and processing the observed image.

ΔHc/Hc of the perpendicular magnetic recording film 5 is preferably equal to or less than 0.25. ΔHc/Hc being equal to or less than 0.25 is preferable because the variation in the diameter of the magnetic particles (crystal particles) is small, the coercive force in the perpendicular direction of the perpendicular magnetic recording film 5 becomes uniform, and thereby it is possible improve the resolution.

The protective film 6 prevents the corrosion of the perpendicular magnetic recording film 5, and at the same time prevents damage to the medium surface when the magnetic head contacts the medium. Thus, it is possible to use conventional well known materials such as C, SiO₂, or ZrO₂.

When the thickness of the protective film 6 is equal to or greater than 1 nm and equal to or less than 7 nm, the distance between the magnetic head and the medium becomes small, and thus is desirable in terms of high recording density.

Preferably, conventional a well known material such as perfluoropolyether, fluorinated alcohols, fluorinated carbons or the like are used in the lubricating film 7.

To manufacture the magnetic recording medium, it is possible to use a method in which the non-magnetic substrate 1, soft magnetic undercoat film 2, first undercoat film 3, second undercoat film 4, and perpendicular magnetic recording film 5 are formed in sequence by sputtering and the like, the protective film 6 is formed by sputtering or CVD, and the lubricating film 7 is formed by dipping or the like.

In the magnetic recording medium of the present embodiment, the first undercoat film 3 consists of Pt, Pd, or an alloy of at least one among them, and the second undercoat film 4 consists of Ru or an Ru alloy. Thereby, the read/write properties and the thermal stability are improved, and it is possible to read and write high density data.

FIG. 4 shows a second embodiment of the magnetic recording medium of the present invention, and the magnetic recording medium shown here provides a seed film 8, which has an amorphous structure or a microcrystalline structure, between the soft magnetic undercoat film 2 and the first undercoat film 3.

Using an alloy including at least one selected from among Fe, Co, and Ni, and at least one selected from among Ta, Nb, Zr, Si, B, C, N, and O is advantageous.

By providing the seed film 8, the first undercoat film 3 can be formed without being influenced by the crystallinity, crystal diameter, or surface state of the soft magnetic undercoat film 2.

It is particularly preferable to use a material for the seed film 8 that has a saturated magnetic flux density Bs equal to or greater than 0.3 T and a coercive force Hc equal to or less than 100 Oe. By using this material for the seed film 8, it is possible to prevent the resolution from deteriorating due to the distance between the magnetic head and the soft magnetic undercoat film 2.

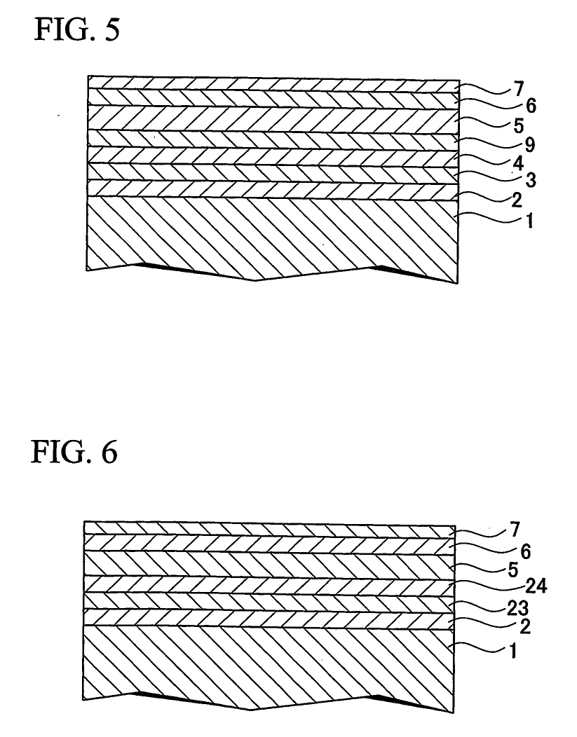

FIG. 5 shows a third embodiment of the magnetic recording medium of the present invention, and the magnetic recording medium shown here provides an intermediate film 9 consisting of a CoCr alloy between the second undercoat film 4 and the perpendicular magnetic recording film 5.

It is advantageous to use a CoCr alloy that includes one selected from among Pt, Ta, Nb, Zr, Si, B, C, and O in the intermediate film 9.

By providing the intermediate film 9, it is possible to prevent the crystallinity of the perpendicular magnetic recording film 5 from deteriorating due to the disorder in the crystallinity in the interface between the second undercoat film 4 and the perpendicular magnetic recording film 5.

The thickness of the intermediate film 9 is preferably equal to or less than 5 nm (more preferably, equal to or less than 3 nm). When the thickness of the intermediate film 9 is within this range, the effect of the intermediate film 9 (preventing the deterioration of the crystallinity of the perpendicular magnetic recording film 5) is increased and the distance between the magnetic head and the soft magnetic undercoat film 2 during reading and writing can be reduced. Thereby, the read/write properties can be improved without decreasing the resolution of the read back signal.

FIG. 6 shows a fourth embodiment of the magnetic recording medium of the present invention. The magnetic recording medium shown here has a structure in which a soft magnetic undercoat film 2, an undercoat film 23 that controls the orientation and the crystal diameter of the film directly above, an intermediate film 24, a perpendicular magnetic recording film 5 in which the easy magnetization axis is oriented generally perpendicular to the substrate, a protective film 6, and a lubricating film 7 are formed in sequence on a non-magnetic substrate 1.

The non-magnetic substrate 1, soft magnetic undercoat film 2, perpendicular magnetic recording film 5, protective film 6 and the lubricating film 7 can have the same composition as those in the first embodiment.

The undercoat film 23 controls the orientation and the crystal diameter of the intermediate film 24 provided directly above or the intermediate film 24 and the perpendicular magnetic recording film 5 provided directly above.

The material used in the intermediate film 23 is an alloy that includes at least Pt and C.

Using Pt without C is not preferable because the crystal diameter becomes large, and thus the crystal diameter in the perpendicular magnetic recording film 5 that is grown epitaxially becomes large due to the influence of the undercoat film 23, and thereby the noise increases.

The undercoat film 23 particularly preferably consists of any among a Pt—C alloy, Pt—Fe—C alloy, Pt—Ni—C alloy, Pt—Co—C alloy, or a Pt—Cr—C alloy.

The material used in the undercoat film 23 can be an alloy that includes at least Pd and C.

In the case that Pd is used without C, the crystal diameter becomes large, and thus the crystal diameter in the perpendicular magnetic recording film 5 that is grown epitaxially becomes large due to the influence of the undercoat film 23, and thereby the noise increases.

In the case that an alloy that includes Pd and C is used, the undercoat film 23 particularly preferably consists of any selected from among a Pd—C alloy, Pd—Fe—C alloy, Pd—Ni—C alloy, Pd—Co—C alloy, or Pd—Cr—C alloy.

The C content of the undercoat film 23 is preferably equal to or greater than 1 at % and equal to or less than 40 at % (more preferably, equal to or greater than 5 at % and equal to or less than 30 at %).

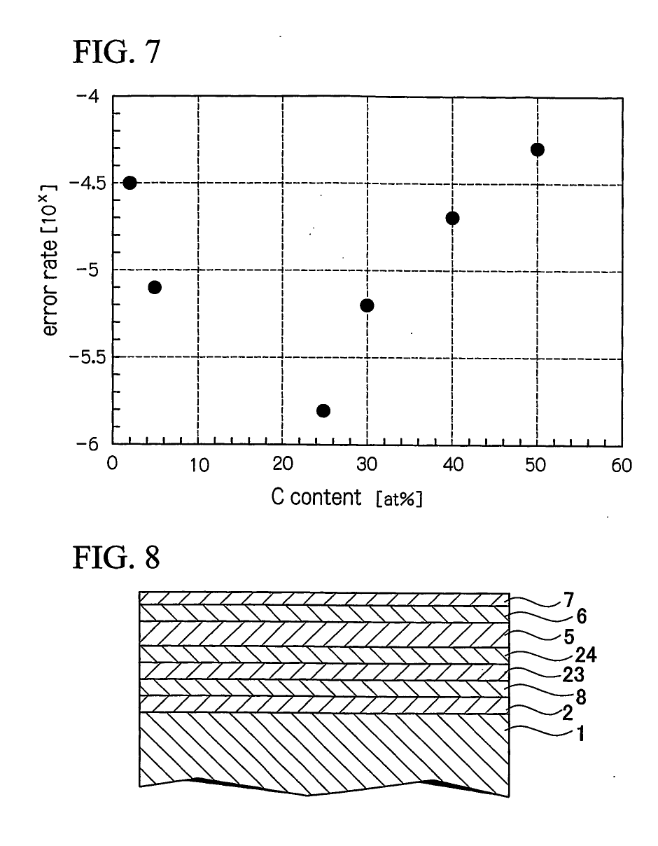

FIG. 7 shows the relationship between the C content of the undercoat film 23 and the read/write properties.

As shown in FIG. 7, the C content of the undercoat film 23 being less than 1 at % , is not preferable because the effect of the improvement on the read/write properties is low. The C content exceeding 40 at % is not desirable because a deterioration of the orientation occurs. As a result, the read/write properties and the magnetostatic properties deteriorate.

The thickness of the undercoat film 23 is preferably equal to or greater than 0.5 nm and equal to or less than 15 nm (in particular, 1 to 10 nm). When the thickness of the undercoat film 23 is within this range, the perpendicular orientation of the perpendicular magnetic recording film 5 is particularly high and the distance between the magnetic head and the soft magnetic undercoat film 2 during reading and writing becomes small. Thus, it is possible to increase the read/write properties without lowering the resolution of the read back signal.

When this thickness falls below the above range, the perpendicular orientation in the perpendicular magnetic recording film 5 is reduced, and the read/write properties and the thermal stability deteriorates.

In addition, when this thickness exceeds the above range, the crystal particles become course and the distance between the magnetic head an the soft magnetic undercoat film 2 during reading and writing increases. Thus, the resolution of the read back signal and the read back output decrease.

The undercoat film 23 preferably has a fcc structure. Due to the undercoat film 23 having a fcc structure, the orientation of the intermediate film 24 provided directly above and/or the perpendicular magnetic recording film 5 is good, and it is possible to make the crystal particles microcrystalline. The state of the particles can be confirmed, for example, by X-ray diffraction or transmission electron microscopy (TEM).

The average diameter of the crystal particles in the undercoat film 23 is equal to or greater than 5 nm and equal to or less than 12 nm. This average diameter can be found, for example, by observing the crystal particles of the undercoat film 23 using TEM (transmission electron microscopy) and processing the observed image.

The surface profile of the undercoat film 23 influences the surface profile of the perpendicular magnetic recording film 5 and the protective film 6, and thus in order to make the surface irregularities of the magnetic recording medium small and decrease the magnetic head flying height during reading and writing, the mean surface roughness Ra of the undercoat film 23 is preferably equal to or less than 2 nm.

Because this mean surface roughness Ra is equal to or less than 2 nm, the surface irregularities of the magnetic recording medium are reduced, the magnetic head flying height during reading and writing is sufficiently decreased, and thereby it is possible to increase the recording density.

When forming the undercoat film 23, with the object of making the crystal particles of the perpendicular magnetic recording film 5 microcrystalline, it is possible to use a process gas that includes oxygen or nitrogen as the gas for film formation. For example, in the case that the undercoat film 23 is formed using a sputtering method, preferably a gas that is a mixture consisting of oxygen mixed into argon at a volume of approximately 0.05 to 10% (preferably, 0.1 to 3%) or a gas that is a mixture consisting of nitrogen mixed into argon at a volume of approximately 0.01 to 20% (preferably, 0.02 to 5%) is used.

The intermediate film 24 prevents distortion in the crystal structure of the perpendicular magnetic recording film 5 due to the difference in the crystal lattice size between the undercoat film 23 and the perpendicular magnetic recording film 5, and at the same time, decreases the exchange coupling of the magnetic particles (crystal particles) in the perpendicular magnetic recording film 5.

Preferably a material having a hcp structure or a fcc structure is used in the intermediate film 24.

The intermediate film 24 preferably includes at least one among Ru and Co.

The thickness of the intermediate film 24 is preferably equal to or less than 10 nm (preferably equal to or less than 6 nm) so as not to cause a deterioration in the read/write properties due to the magnetic particles (crystal particles) in the perpendicular magnetic recording film 5 becoming coarse or a decrease in the resolution because of increase in the distance between the magnetic head and the undercoat film 2.

The thickness of the intermediate film 24 can be made a value that exceeds 10 nm (for example, equal to or greater than 15 nm).

Note that in the present invention a structure that does not provide the intermediate film 24 is also possible.

To manufacture the magnetic recording medium described above, a method used in which the soft magnetic undercoat film 2, the undercoat film 23, intermediate film 24, and the perpendicular magnetic recording film 5 are formed in sequence on the non-magnetic substrate 1 by a sputtering method or the like, the protective film 6 is formed by a sputtering method, a CVD method or the like, and the lubricating film 7 is formed by a dipping method or the like.

Preferably, the undercoat film 23 is formed at a temperature of 150 to 400° C.

Superior read/write properties can be obtained when the temperature is in this range.

In the magnetic recording medium of the present embodiment, the undercoat film 23 consists of an alloy that includes at least Pt and C or an alloy that includes at least Pd and C, and thus the read/write properties and the thermal stability improve, and the reading and writing of high density data becomes possible.

FIG. 8 shows a fifth embodiment of the magnetic recording medium of the present invention. The magnetic recording medium shown here provides a seed film 8 having an amorphous structure or a microcrystalline structure between the soft magnetic undercoat film 2 and the undercoat film 23.

The seed film 8 can be formed identically to that shown in the second embodiment.

By providing the seed film 8, it is possible to form the undercoat film 23 without being influenced by the crystallinity, the crystal grain diameter, or the surface condition of the soft magnetic undercoat film 2.

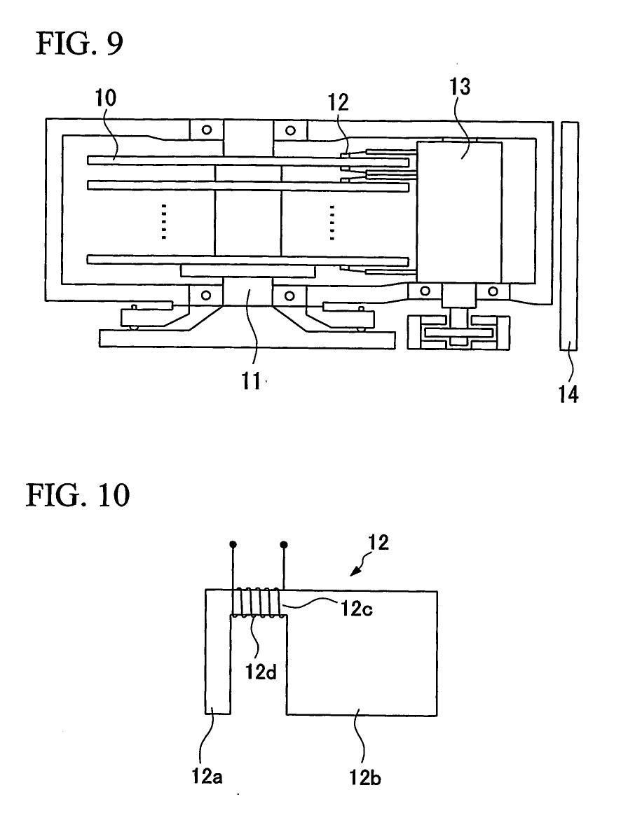

FIG. 9 shows an Example of the magnetic read/write apparatus using the magnetic recording medium described above. The magnetic read/write apparatus shown here provides the magnetic recording medium 10 in any of the embodiments described above, a medium drive unit 11 that rotates the magnetic recording medium 10, a magnetic head that reads and writes information on the magnetic recording medium 10, a head drive unit 13, and a read/write signal processing system 14. The read/write signal processing system 14 processes input data and sends a record signal to the magnetic head 12, and it becomes possible to output data by processing the read back signal from the magnetic head 12.

A single pole head for perpendicular magnetic recording can be used as the magnetic head 12.

As shown in FIG. 10, it is possible to use a single pole head comprising a main pole 12a, an auxiliary pole 12b, and a coil 12d that are provided on the communicating part 12c thereof.

According to the magnetic read/write apparatus described above, because of using the magnetic recording medium 10 described above, it is possible to increase both the thermal stability and the read/write properties.

Therefore, according to the magnetic read/write apparatus, troubles such as data loss due to thermal fluctuation can be prevented from occurring, and at the same time it is possible to implement high recording density.

The operational effect of the present invention will now be clarified by way of examples. However, the present invention is not limited to the following examples.

### EXAMPLE 1

A cleaned glass substrate 1 (Ohara Co. of JAPAN, external diameter: 2.5 inches) was accommodated in the film formation chamber of a DC magnetron sputtering apparatus (ANELVA of JAPAN, C-3010). After air was expelled from the film formation chamber until an ultimate vacuum of 1×10⁻⁵ Pa was attained, a soft magnetic undercoat film 2 having a thickness of 180 nm was formed on the substrate 1 using a sputtering method by using a target consisting of 89Co-4Zr-7Nb (a Co content of 89 at % , a Zr content of 4 at % , and an Nb content of 7 at % ). It was confirmed by using a vibrating sample magnetometer (VSM) that the product of the saturation magnetic flux Bs and the film thickness t, that is, B·t, of this film was 200 T·nm.

Next, at 240° C., a first undercoat film 3 having a thickness of 5 nm was formed on the soft magnetic undercoat film 2 described above by using a 75Pt-25C (Pt content of 75 at % and a C content of 25 at % ) target. At this point in time, the crystal particles of the surface of the first undercoat film 3 were observed using TEM, and found to have an average diameter of 8 nm.

On the first undercoat film 3, the second undercoat film 4 having a thickness of 5 nm was formed by using a Ru target, and the perpendicular magnetic recording film 5 having a thickness of 20 nm was formed by using a 64Co-17Cr-17Pt-2B (Co content at 64 at % , Cr content at 17 at % , Pt content at 17 at % and B content at 2 at % ) target. Note that in the sputtering step described above, argon was used as the processing gas for film formation, and the film was formed under a pressure of 0.6 Pa.

Next, a protective film 6 having a thickness of 5 nm was formed by using CVD.

After that, a lubricating film 7 consisting of a perfluoropolyether was formed using a dipping method, and a magnetic recording medium was obtained. The composition of this magnetic recording medium is shown in Table 1.

### COMPARATIVE EXAMPLE 1

Except for the first undercoat film 3 not being provided, the magnetic recording medium was fabricated according to Example 1. The composition of this magnetic recording medium is shown in Table 1.

### COMPARATIVE EXAMPLES 2 AND 3

Except for the second undercoat film 4 not being provided, the magnetic recording media were fabricated according to Example 1. The compositions of these magnetic recording media are shown in Table 1.

The magnetic recording media in the Example and the Comparative Examples were evaluated. The evaluation of the read/write properties was carried out by using a read/write analyzer RWA1632 and a spin stand S1701MP manufactured by GIZIK Co. (USA).

In the evaluation of the read/write properties, a magnetic head using a single pole electrode in the write portion and using a GMR element in the read back portion were employed, and the recording frequency conditions were measured as a track recording density of 600 kFCI.

In the evaluation of the thermal fluctuation properties, the spin stand described above, and the magnetic head described above were used. After writing at a track recording density of 50 kFCI at a temperature of 70° C., the rate of decrease (%/decade) of the output with respect to the read back output after writing 1 second was calculated based on (S-Sₒ)×100/(S₀×3). In this equation, Sₒ denotes the read back output after the passage of 1 second after writing the signal on the magnetic recording medium, and S denotes the read back output after 1000 seconds. The results of the test are shown in Table 1.

TABLE 1

| | Soft magnetic | | | | | | Perpendicular magnetic recording | |
|---|---|---|---|---|---|---|---|---|
| | undercoat film | | First undercoat film | | Second undercoat film | | film | |
| | | Bs · t | Composition | Thickness | Composition | Thickness | Composition | Thickness |
| | Composition | (T · nm) | (at %) | (nm) | (at %) | (nm) | (at %) | (nm) |
| Example 1 | CoZrNb | 200 | 75Pt—25C | 5 | Ru | 5 | 64Co—17Cr—17Pt—2B | 20 |
| Comparative | CoZrNb | 200 | — | — | Ru | 5 | 64Co—17Cr—17Pt—2B | 20 |
| Example 1 | | | | | | | | |
| Comparative | CoZrNb | 200 | 75Pt—25C | 5 | — | — | 64Co—17Cr—17Pt—2B | 20 |
| Example 2 | | | | | | | | |
| Comparative | CoZrNb | 200 | Pt | 5 | — | — | 64Co—17Cr—17Pt—2B | 20 |
| Example 3 | | | | | | | | |

| | Read/write | Thermal | | | |
|---|---|---|---|---|---|
| | properties | stability | Magnetic properties | | |
| | error rate | Properties | | | -Hn |
| | (10^{x}) | (%/decade) | Hc (Oe) | Mr/Ms | (Oe) |
| Example 1 | −5.8 | −0.2 | 4535 | 1.00 | 1050 |
| Comparative | −3.1 | −2.1 | 4250 | 0.80 | −200 |
| Example 1 | | | | | |
| Comparative | −4.8 | −0.3 | 4400 | 1.00 | 900 |
| Example 2 | | | | | |
| Comparative | −4.0 | −0.2 | 4500 | 1.00 | 1000 |
| Example 3 | | | | | |

As shown in Table 1, the Examples providing the first undercoat film 3 and the second undercoat film 4 showed read/write properties that were superior compared to the comparative Example.

### EXAMPLES 2 TO 12

Except for the composition of the first undercoat film 3 shown in Table 2, the magnetic recording media were fabricated according to Example 1.

The read/write properties of the magnetic recording media in these Examples were evaluated. The results of the tests are shown in Table 2.

TABLE 2

| | Soft magnetic | | | | | | Perpendicular magnetic | |
|---|---|---|---|---|---|---|---|---|
| | undercoat film | | First undercoat film | | Second undercoat film | | recording film | |
| | | Bs · t | Composition | Thickness | Composition | Thickness | Composition | Thickness |
| | Composition | (T · nm) | (at %) | (nm) | (at %) | (nm) | (at %) | (nm) |
| Example 1 | CoZrNb | 200 | 75Pt—25C | 5 | Ru | 5 | 64Co—17Cr—17Pt—2B | 20 |
| Example 2 | CoZrNb | 200 | Pt | 5 | Ru | 5 | 64Co—17Cr—17Pt—2B | 20 |
| Example 3 | CoZrNb | 200 | 85Pt—15B | 5 | Ru | 5 | 64Co—17Cr—17Pt—2B | 20 |
| Example 4 | CoZrNb | 200 | 85Pt—15P | 5 | Ru | 5 | 64Co—17Cr—17Pt—2B | 20 |
| Example 5 | CoZrNb | 200 | 75Pt—25Si | 5 | Ru | 5 | 64Co—17Cr—17Pt—2B | 20 |
| Example 6 | CoZrNb | 200 | 60Pt—40Cr | 5 | Ru | 5 | 64Co—17Cr—17Pt—2B | 20 |
| Example 7 | CoZrNb | 200 | 80Pt—20Pr | 5 | Ru | 5 | 64Co—17Cr—17Pt—2B | 20 |
| Example 8 | CoZrNb | 200 | 80Pt—20Sm | 5 | Ru | 5 | 64Co—17Cr—17Pt—2B | 20 |
| Example 9 | CoZrNb | 200 | 80Pt—20Nd | 5 | Ru | 5 | 64Co—17Cr—17Pt—2B | 20 |
| Example 10 | CoZrNb | 200 | 50Pt—25Fe—25C | 5 | Ru | 5 | 64Co—17Cr—17Pt—2B | 20 |
| Example 11 | CoZrNb | 200 | 50Pt—25Ni—25C | 5 | Ru | 5 | 64Co—17Cr—17Pt—2B | 20 |
| Example 12 | CoZrNb | 200 | 90Pt—10SiO₂ | 5 | Ru | 5 | 64Co—17Cr—17Pt—2B | 20 |

| | Read/write | | | | |
|---|---|---|---|---|---|
| | properties | Thermal stability | Magnetic properties | | |
| | error rate | Properties | | | -Hn |
| | (10^{x}) | (%/decade) | Hc (Oe) | Mr/Ms | (Oe) |
| Example 1 | −5.8 | −0.2 | 4534 | 1.00 | 1050 |
| Example 2 | −4.9 | −0.2 | 4500 | 1.00 | 1100 |
| Example 3 | −5.6 | −0.2 | 4335 | 0.99 | 1000 |
| Example 4 | −5.5 | −0.2 | 4400 | 1.00 | 950 |
| Example 5 | −5.2 | −0.4 | 4440 | 0.97 | 800 |
| Example 6 | −5.0 | −0.5 | 4200 | 0.95 | 750 |
| Example 7 | −5.5 | −0.1 | 4665 | 1.00 | 950 |
| Example 8 | −5.5 | −0.2 | 4700 | 1.00 | 1000 |
| Example 9 | −5.5 | −0.2 | 4525 | 1.00 | 950 |
| Example 10 | −5.8 | −0.1 | 4665 | 1.00 | 950 |
| Example 11 | −5.8 | −0.2 | 4700 | 1.00 | 1000 |
| Example 12 | −5.9 | −0.2 | 4025 | 0.91 | 400 |

As shown in Table 2, the Examples in which the first undercoat film 3 consists of Pt or a Pt alloy showed superior read/write properties.

### EXAMPLES 13 TO 16

Except for the thickness of the first undercoat film 3 shown in Table 3, the magnetic recording media were fabricated according to Example 1.

The read/write properties of the magnetic recording media in these Examples were evaluated. The results of the tests are shown in Table 3.

TABLE 3

| | Soft magnetic | | | | | |
|---|---|---|---|---|---|---|
| | undercoat film | | First undercoat film | | Second undercoat film | |
| | | Bs · t | Composition | | Composition | |
| | Composition | (T · nm) | (at %) | Thickness (nm) | (at %) | Thickness (nm) |
| Example 1 | CoZrNb | 200 | 75Pt—25C | 5 | Ru | 5 |
| Example 13 | CoZrNb | 200 | 75Pt—25C | 0.5 | Ru | 5 |
| Example 14 | CoZrNb | 200 | 75Pt—25C | 1 | Ru | 5 |
| Example 15 | CoZrNb | 200 | 75Pt—25C | 10 | Ru | 5 |
| Example 16 | CoZrNb | 200 | 75Pt—25C | 25 | Ru | 5 |

| | Perpendicular magnetic | | Read/write | Thermal | Magnetic | | |
|---|---|---|---|---|---|---|---|
| | recording film | | properties | stability | properties | | |
| | Composition | Thickness | error rate | Properties | Hc | | -Hn |
| | (at %) | (nm) | (10^{x}) | (%/decade) | (Oe) | Mr/Ms | (Oe) |
| Example 1 | 64Co—17Cr—17Pt—2B | 20 | −5.8 | −0.2 | 4535 | 1.00 | 1050 |
| Example 13 | 64Co—17Cr—17Pt—2B | 20 | −4.4 | −0.7 | 4100 | 0.90 | 200 |
| Example 14 | 64Co—17Cr—17Pt—2B | 20 | −5.4 | −0.5 | 4300 | 0.93 | 350 |
| Example 15 | 64Co—17Cr—17Pt—2B | 20 | −5.1 | −0.2 | 4610 | 1.00 | 1000 |
| Example 16 | 64Co—17Cr—17Pt—2B | 20 | −4.4 | −0.2 | 4465 | 0.97 | 750 |

As shown in Table 3, the Examples in which the thickness of the first undercoat film 3 was equal to or greater than 0.5 nm and equal to or less than 10 nm (in particular, 1 to 7 nm) showed superior read/write properties.

### EXAMPLES 17 TO 20

Except for the composition of the second undercoat film 4 shown in Table 4, the magnetic recording media were fabricated according to Example 1.

The read/write properties of the magnetic recording media in these Examples were evaluated. The results of the tests are shown in Table 4.

TABLE 4

| | Soft magnetic | | | | | |
|---|---|---|---|---|---|---|
| | undercoat film | | First undercoat film | | Second undercoat film | |
| | | Bs · t | Composition | | Composition | Thickness |
| | Composition | (T · nm) | (at %) | Thickness (nm) | (at %) | (nm) |
| Example 1 | CoZrNb | 200 | 75Pt—25C | 5 | Ru | 5 |
| Example 17 | CoZrNb | 200 | 75Pt—25C | 5 | 80Ru—20B | 5 |
| Example 18 | CoZrNb | 200 | 75Pt—25C | 5 | 80Ru—20C | 5 |
| Example 19 | CoZrNb | 200 | 75Pt—25C | 5 | 60Ru—40W | 5 |
| Example 20 | CoZrNb | 200 | 75Pt—25C | 5 | 50Ru—50Mo | 5 |

| | Perpendicular magnetic | | Read/write | Thermal | | | |
|---|---|---|---|---|---|---|---|
| | recording film | | properties | stability | Magnetic properties | | |
| | Composition | Thickness | error rate | Properties | Hc | Mr/ | -Hn |
| | (at %) | (nm) | (10^{x}) | (%/decade) | (Oe) | Ms | (Oe) |
| Example 1 | 64Co—17Cr—17Pt—2B | 20 | −5.8 | −0.2 | 4535 | 1.00 | 1050 |
| Example 17 | 64Co—17Cr—17Pt—2B | 20 | −5.9 | −0.2 | 4555 | 0.79 | 1100 |
| Example 18 | 64Co—17Cr—17Pt—2B | 20 | −6.0 | −0.1 | 4435 | 1.00 | 1000 |
| Example 19 | 64Co—17Cr—17Pt—2B | 20 | −6.0 | −0.1 | 4755 | 1.00 | 1200 |
| Example 20 | 64Co—17Cr—17Pt—2B | 20 | −6.1 | −0.2 | 4785 | 1.00 | 1250 |

As shown in Table 4, the Examples in which the second undercoat film 4 consisted of Ru or an Ru alloy showed superior read/write properties.

### EXAMPLES 21 TO 25

Except for the thickness of the second undercoat film 4 shown in Table 5, the magnetic recording media were fabricated according to Example 1.

The read/write properties of the magnetic recording media in these Examples were evaluated. The results of the tests are shown in Table 5.

TABLE 5

| | Soft magnetic | | First undercoat | | Second | |
|---|---|---|---|---|---|---|
| | undercoat film | | film | | undercoat film | |
| | | Bs · t | Composition | | Composition | |
| | Composition | (T · nm) | (at %) | Thickness (nm) | (at %) | Thickness (nm) |
| Example 1 | CoZrNb | 200 | 75Pt—25C | 5 | Ru | 5 |
| Example 21 | CoZrNb | 200 | 75Pt—25C | 5 | Ru | 0.5 |
| Example 22 | CoZrNb | 200 | 75Pt—25C | 5 | Ru | 1 |
| Example 23 | CoZrNb | 200 | 75Pt—25C | 5 | Ru | 7 |
| Example 24 | CoZrNb | 200 | 75Pt—25C | 5 | Ru | 10 |
| Example 25 | CoZrNb | 200 | 75Pt—25C | 5 | Ru | 25 |

| | Perpendicular magnetic | | Read/write | Thermal | | | |
|---|---|---|---|---|---|---|---|
| | recording film | | properties | stability | Magnetic properties | | |
| | Composition | Thickness | error rate | Properties | Hc | | -Hn |
| | (at %) | (nm) | (10^{x}) | (%/decade) | (Oe) | Mr/Ms | (Oe) |
| Example 1 | 64Co—17Cr—17Pt—2B | 20 | −5.8 | −0.2 | 4535 | 1.00 | 1050 |
| Example 21 | 64Co—17Cr—17Pt—2B | 20 | −5.2 | −0.2 | 4555 | 0.99 | 1100 |
| Example 22 | 64Co—17Cr—17Pt—2B | 20 | −5.5 | −0.1 | 4435 | 1.00 | 1000 |
| Example 23 | 64Co—17Cr—17Pt—2B | 20 | −5.5 | −0.1 | 4600 | 1.00 | 1000 |
| Example 24 | 64Co—17Cr—17Pt—2B | 20 | −5.1 | −0.2 | 4655 | 0.98 | 1250 |
| Example 25 | 64Co—17Cr—17Pt—2B | 20 | −4.6 | −0.5 | 4275 | 1.00 | 550 |

As shown in Table 5, the Examples in which the thickness of the second undercoat film 4 was equal to or greater than 0.5 nm and equal to or less than 10 nm (in particular, 1 to 7 nm) showed superior read/write properties.

### EXAMPLES 26 TO 32

Except for the material and thickness of the soft magnetic undercoat film 2 shown in Table 6, the magnetic recording media were fabricated according to Example 1.

### EXAMPLES 33 TO 35

Except for providing the seed film 8 between the soft magnetic undercoat film 2 and the first undercoat film 3, the magnetic recording media were fabricated according to Example 1.

The read/write properties of the magnetic recording media in these Examples were evaluated. The results of the tests are shown in Table 6.

TABLE 6

| | Soft magnetic | | | | First undercoat | | Second undercoat | |
|---|---|---|---|---|---|---|---|---|
| | undercoat film | | Seed film | | film | | film | |
| | | Bs · t | Composition | Thickness | Composition | Thickness | Composition | Thickness |
| | Composition | (T · nm) | (at %) | (nm) | (at %) | (nm) | (at %) | (nm) |
| Example 1 | CoZrNb | 200 | — | — | 75Pt—25C | 5 | Ru | 5 |
| Example 26 | FeCoB | 200 | — | — | 75Pt—25C | 5 | Ru | 5 |
| Example 27 | FeTaC | 200 | — | — | 75Pt—25C | 5 | Ru | 5 |
| Example 28 | CoNiP | 200 | — | — | 75Pt—25C | 5 | Ru | 5 |
| Example 29 | FeCoNiP | 200 | — | — | 75Pt—25C | 5 | Ru | 5 |
| Example 30 | FeAlO | 200 | — | — | 75Pt—25C | 5 | Ru | 5 |
| Example 31 | CoZrNb | 60 | — | — | 75Pt—25C | 5 | Ru | 5 |
| Example 32 | CoZrNb | 400 | — | — | 75Pt—25C | 5 | Ru | 5 |
| Example 33 | CoZrNb | 200 | NiTa | 10 | 75Pt—25C | 5 | Ru | 5 |
| Example 34 | CoZrNb | 200 | CoZr | 10 | 75Pt—25C | 5 | Ru | 5 |
| Example 35 | CoZrNb | 200 | FeTaN | 10 | 75Pt—25C | 5 | Ru | 5 |

| | Perpendicular magnetic | | read/write | Thermal | | | |
|---|---|---|---|---|---|---|---|
| | recording film | | properties | stability | Magnetic properties | | |
| | Composition | Thickness | error rate | Properties | Hc | | -Hn |
| | (at %) | (nm) | (10^{x}) | (%/decade) | (Oe) | Mr/Ms | (Oe) |
| Example 1 | 64Co—17Cr—17Pt—2B | 20 | −5.8 | −0.2 | 4535 | 1.00 | 1050 |
| Example 26 | 64Co—17Cr—17Pt—2B | 20 | −5.6 | −0.2 | 4625 | 1.00 | 1100 |
| Example 27 | 64Co—17Cr—17Pt—2B | 20 | −5.4 | −0.2 | 4400 | 0.99 | 1000 |
| Example 28 | 64Co—17Cr—17Pt—2B | 20 | −5.9 | −0.2 | 4515 | 1.00 | 950 |
| Example 29 | 64Co—17Cr—17Pt—2B | 20 | −6.0 | −0.1 | 4445 | 1.00 | 1200 |
| Example 30 | 64Co—17Cr—17Pt—2B | 20 | −5.4 | −0.3 | 4390 | 1.00 | 1000 |
| Example 31 | 64Co—17Cr—17Pt—2B | 20 | −4.9 | −0.1 | 4550 | 1.00 | 950 |
| Example 32 | 64Co—17Cr—17Pt—2B | 20 | −6.0 | −0.2 | 4420 | 1.00 | 1100 |
| Example 33 | 64Co—17Cr—17Pt—2B | 20 | −6.1 | −0.2 | 4500 | 1.00 | 1000 |
| Example 34 | 64Co—17Cr—17Pt—2B | 20 | −6.0 | −0.2 | 4545 | 0.99 | 950 |
| Example 35 | 64Co—17Cr—17Pt—2B | 20 | −6.2 | −0.1 | 4560 | 1.00 | 950 |

As shown in Table 6, the Examples show superior read/write properties. In particular, in the Examples in which the seed film 8 was provided, superior read/write properties were obtained.

### EXAMPLES 36 TO 40

Except for providing the intermediate film 9 between the second undercoat film 4 and the perpendicular magnetic recording film 5, the magnetic recording media were fabricated according to Example 1.

### EXAMPLES 41 TO 44

Except for the material and thickness of the perpendicular magnetic recording film 5 shown in Table 7, the magnetic recording media were fabricated according to Example 1.

The read/write properties of the magnetic recording media in these Examples were evaluated. The results of the test are shown in Table 7.

TABLE 7

| | Soft magnetic | | First undercoat | | Second undercoat | | Intermediate | |
|---|---|---|---|---|---|---|---|---|
| | undercoat film | | film | | film | | film | |
| | | Bs · t | Composition | Thickness | Composition | Thickness | Composition | Thickness |
| | Composition | (T · nm) | (at %) | (nm) | (at %) | (nm) | (at %) | (nm) |
| Example 1 | CoZrNb | 200 | 75Pt—25C | 5 | Ru | 5 | — | — |
| Example 36 | CoZrNb | 200 | 75Pt—25C | 5 | Ru | 5 | 70Co—30Cr | 2 |
| Example 37 | CoZrNb | 200 | 75Pt—25C | 5 | Ru | 5 | 60Co—30Cr—10Pt | 2 |
| Example 38 | CoZrNb | 200 | 75Pt—25C | 5 | Ru | 5 | 60Co—25Cr—10Pt—5B | 2 |
| Example 39 | CoZrNb | 200 | 75Pt—25C | 5 | Ru | 5 | 60Co—30Cr—10Pt | 5 |
| Example 40 | CoZrNb | 200 | 75Pt—25C | 5 | Ru | 5 | 60Co—30Cr—10Pt | 10 |
| Example 41 | CoZrNb | 200 | 75Pt—25C | 5 | Ru | 5 | — | — |
| Example 42 | CoZrNb | 200 | 75Pt—25C | 5 | Ru | 5 | — | — |
| Example 43 | CoZrNb | 200 | 75Pt—25C | 5 | Ru | 5 | — | — |
| Example 44 | CoZrNb | 200 | 75Pt—25C | 5 | Ru | 5 | — | — |

| | Perpendicular magnetic | | read/write | Thermal | | | |
|---|---|---|---|---|---|---|---|
| | recording film | | properties | stability | Magnetic properties | | |
| | Composition | Thickness | error rate | Properties | Hc | | -Hn |
| | (at %) | (nm) | (10^{x}) | (%/decade) | (Oe) | Mr/Ms | (Oe) |
| Example 1 | 64Co—17Cr—17Pt—2B | 20 | −5.8 | −0.2 | 4535 | 1.00 | 1050 |
| Example 36 | 64Co—17Cr—17Pt—2B | 20 | −6.0 | −0.1 | 4500 | 1.00 | 1100 |
| Example 37 | 64Co—17Cr—17Pt—2B | 20 | −6.2 | −0.2 | 4700 | 0.99 | 900 |
| Example 38 | 64Co—17Cr—17Pt—2B | 20 | −6.3 | −0.2 | 4385 | 1.00 | 950 |
| Example 39 | 64Co—17Cr—17Pt—2B | 20 | −6.0 | −0.2 | 4565 | 1.00 | 1000 |
| Example 40 | 64Co—17Cr—17Pt—2B | 20 | −5.5 | −0.2 | 4765 | 0.95 | 1200 |
| Example 41 | 61Co—22Cr—17Pt | 20 | −5.9 | −0.4 | 4630 | 0.91 | 400 |
| Example 42 | 67Co—10Cr—17Pt—6SiO₂ | 20 | −5.1 | −0.1 | 4800 | 1.00 | 1200 |
| Example 43 | 64Co—17Cr—17Pt—2B | 10 | −5.5 | −0.4 | 3955 | 0.91 | 450 |
| Example 44 | 64Co—17Cr—17Pt—2B | 30 | −5.1 | −0.1 | 4300 | 0.99 | 850 |

As shown in Table 7, the Examples showed superior read/write properties.

### EXAMPLE 45

Except for forming the first undercoat film 3 as explained below, the magnetic recording media were fabricated according to Example 1.

Specifically, a first undercoat film 3 having a thickness of 5 nm was formed on the soft magnetic undercoat film 2 by using a 75Pd-25C (Pd content at 75 at % and C content at 25 at % ) target. At this point in time, the crystal particles of the surface of the undercoat film 3 were observed using TEM, and found to have an average diameter of 8.3 nm.

The read/write properties of the magnetic recording medium in this Example were evaluated. The results of the tests are shown in Table 8.

### COMPARATIVE EXAMPLES 4 AND 5

Except for not providing the second undercoat film 4, the magnetic recording media were fabricated according to Example 45. The read/write properties of the magnetic recording media were evaluated. The results of the tests are shown in FIG. 8.

### EXAMPLES 46 TO 54

Except for the composition and thickness of the first undercoat film 3 shown in Table 8, the magnetic recording media were fabricated according to Example 45.

The read/write properties of the magnetic recording media in these Examples were evaluated. The results of the tests are shown in Table 8.

TABLE 8

| | Soft magnetic | | First undercoat | | Second undercoat | |
|---|---|---|---|---|---|---|
| | undercoat film | | film | | film | |
| | | Bs · t | Composition | Thickness | Composition | Thickness |
| | Composition | (T · nm) | (at %) | (nm) | (at %) | (nm) |
| Example 45 | CoZrNb | 200 | 75Pd—25C | 5 | Ru | 5 |
| Example 46 | CoZrNb | 200 | 75Pd—25C | 25 | Ru | 5 |
| Example 47 | CoZrNb | 200 | Pd | 5 | Ru | 5 |
| Example 48 | CoZrNb | 200 | 80Pd—20B | 5 | Ru | 5 |
| Example 49 | CoZrNb | 200 | 85Pd—15Si | 5 | Ru | 5 |
| Example 50 | CoZrNb | 200 | 60Pd—40Cr | 5 | Ru | 5 |
| Example 51 | CoZrNb | 200 | 85Pd—15Sm | 5 | Ru | 5 |
| Example 52 | CoZrNb | 200 | 50Pd—25Ni—25C | 5 | Ru | 5 |
| Example 53 | CoZrNb | 200 | 50Pd—30Pt—20C | 5 | Ru | 5 |
| Example 54 | CoZrNb | 200 | 90Pd—10MgO | 5 | Ru | 5 |
| Comparative | CoZrNb | 200 | — | — | Ru | 5 |
| Example 1 | | | | | | |
| Comparative | CoZrNb | 200 | 75Pd—25C | 5 | — | — |
| Example 4 | | | | | | |
| Comparative | CoZrNb | 200 | Pd | 5 | — | — |
| Example 5 | | | | | | |

| | Perpendicular magnetic | | Read/write | Thermal | Magnetic | | |
|---|---|---|---|---|---|---|---|
| | recording film | | properties | stability | properties | | |
| | Composition | Thickness | error rate | Properties | Hc | Mr/ | -Hn |
| | (at %) | (nm) | (10^{x}) | (%/decade) | (Oe) | Ms | (Oe) |
| Example 45 | 64Co—17Cr—17Pt—2B | 20 | −5.6 | −0.2 | 4590 | 1 | 1000 |
| Example 46 | 64Co—17Cr—17Pt—2B | 20 | −4.4 | −0.1 | 4760 | 1 | 1200 |
| Example 47 | 64Co—17Cr—17Pt—2B | 20 | −4.8 | −0.3 | 4470 | 1 | 850 |
| Example 48 | 64Co—17Cr—17Pt—2B | 20 | −5.5 | −0.2 | 4510 | 1 | 800 |
| Example 49 | 64Co—17Cr—17Pt—2B | 20 | −5.2 | −0.4 | 4390 | 0.96 | 650 |
| Example 50 | 64Co—17Cr—17Pt—2B | 20 | −5.0 | −0.5 | 4440 | 0.93 | 400 |
| Example 51 | 64Co—17Cr—17Pt—2B | 20 | −5.8 | −0.3 | 4530 | 0.97 | 900 |
| Example 52 | 64Co—17Cr—17Pt—2B | 20 | −5.8 | −0.2 | 4650 | 1 | 1000 |
| Example 53 | 64Co—17Cr—17Pt—2B | 20 | −6.1 | −0.1 | 4740 | 1 | 1050 |
| Example 54 | 64Co—17Cr—17Pt—2B | 20 | −5.3 | −0.4 | 4340 | 0.91 | 400 |
| Comparative | 64Co—17Cr—17Pt—2B | 20 | −3.1 | −2.1 | 4250 | 0.8 | −200 |
| Example 1 | | | | | | | |
| Comparative | 64Co—17Cr—17Pt—2B | 20 | −4.3 | −0.4 | 4420 | 0.97 | 650 |
| Example 4 | | | | | | | |
| Comparative | 64Co—17Cr—17Pt—2B | 20 | −3.5 | −0.7 | 4200 | 0.94 | 550 |
| Example 5 | | | | | | | |

As shown in Table 8, the Examples in which the first undercoat film 3 consists of Pd or a Pd alloy showed superior read/write properties. Superior read/write properties were obtained in the case of using an alloy that included Pt and Pd as well.

### EXAMPLES 55 TO 77

Except for the composition and thickness of the first undercoat film 3, the second undercoat film 4, and the perpendicular magnetic recording film 5 shown in Table 9, the magnetic recording media were fabricated according to Example 1.

The read/write properties of magnetic recording media in these Examples were evaluated. The results of the tests are shown in Table 9.

TABLE 9

| | Soft magnetic | | First undercoat | | Second undercoat | | Intermediate | |
|---|---|---|---|---|---|---|---|---|
| | undercoat film | | film | | film | | film | |
| | | Bs · t | Composition | Thickness | Composition | Thickness | Composition | Thickness |
| | Composition | (T · nm) | (at %) | (nm) | (at %) | (nm) | (at %) | (nm) |
| Example 1 | CoZrNb | 200 | 75Pt—25C | 5 | Ru | 5 | — | — |
| Example 55 | CoZrNb | 200 | Pt | 5 | Ru | 20 | — | — |
| Example 56 | CoZrNb | 200 | 90Pt—10SiO₂ | 5 | Ru | 20 | — | — |
| Example 57 | CoZrNb | 200 | 95Pt—5SiO₂ | 5 | Ru | 20 | — | — |
| Example 58 | CoZrNb | 200 | 80Pt—20SiO₂ | 5 | Ru | 20 | — | — |
| Example 59 | CoZrNb | 200 | 90Pt—10Al₂O₃ | 5 | Ru | 20 | — | — |
| Example 60 | CoZrNb | 200 | 90Pt—10CaO | 5 | Ru | 20 | — | — |
| Example 61 | CoZrNb | 200 | 90Pt—10Ta₂O₅ | 5 | Ru | 20 | — | — |
| Example 62 | CoZrNb | 200 | 90Pd—10SiO₂ | 5 | Ru | 20 | — | — |
| Example 63 | CoZrNb | 200 | Pt | 5 | 90Ru—10SiO₂ | 20 | — | — |
| Example 64 | CoZrNb | 200 | Pt | 5 | 90Ru—10Al₂O₃ | 20 | — | — |
| Example 65 | CoZrNb | 200 | Pt | 5 | 90Ru—10CoO | 20 | — | — |
| Example 66 | CoZrNb | 200 | Pt | 5 | 90Ru—10Ta₂O₅ | 20 | — | — |
| Example 67 | CoZrNb | 200 | 90Pt—10SiO₂ | 5 | 90Ru—10SiO₂ | 20 | — | — |
| Example 68 | CoZrNb | 200 | Pt | 5 | Ru | 20 | — | — |
| Example 69 | CoZrNb | 200 | Pt | 5 | Ru | 20 | — | — |
| Example 70 | CoZrNb | 200 | Pt | 5 | Ru | 20 | — | — |
| Example 71 | CoZrNb | 200 | Pt | 5 | Ru | 20 | — | — |
| Example 72 | CoZrNb | 200 | Pt | 5 | Ru | 20 | — | — |
| Example 73 | CoZrNb | 200 | Pt | 5 | Ru | 20 | — | — |
| Example 74 | CoZrNb | 200 | Pt | 5 | Ru | 20 | — | — |
| Example 75 | CoZrNb | 200 | Pt | 5 | Ru | 20 | — | — |
| Example 76 | CoZrNb | 200 | Pt | 5 | Ru | 20 | — | — |
| Example 77 | CoZrNb | 200 | Pt | 5 | Ru | 20 | — | — |

| | Perpendicular magnetic | | read/write | Thermal | | | |
|---|---|---|---|---|---|---|---|
| | recording film | | properties | stability | Magnetic properties | | |
| | Composition | Thickness | error rate | Properties | Hc | | -Hn |
| | (at %) | (nm) | (10^{x}) | (%/decade) | (Oe) | Mr/Ms | (Oe) |
| Example 1 | 64Co—17Cr—17Pt—2B | 20 | −5.8 | −0.2 | 4535 | 1 | 1050 |
| Example 55 | 65Co—10Cr—17Pt—8SiO₂ | 15 | −5.7 | −0.1 | 4455 | 1 | 1250 |
| Example 56 | 65Co—10Cr—17Pt—8SiO₂ | 15 | −6.9 | −0.2 | 4290 | 1 | 1000 |
| Example 57 | 65Co—10Cr—17Pt—8SiO₂ | 15 | −6.1 | −0.1 | 4440 | 1 | 1050 |
| Example 58 | 65Co—10Cr—17Pt—8SiO₂ | 15 | −6.2 | −0.4 | 3990 | 1 | 1075 |
| Example 59 | 65Co—10Cr—17Pt—8SiO₂ | 15 | −6.6 | −0.1 | 4315 | 1 | 1025 |
| Example 60 | 65Co—10Cr—17Pt—8SiO₂ | 15 | −6.2 | −0.1 | 4290 | 1 | 995 |
| Example 61 | 65Co—10Cr—17Pt—8SiO₂ | 15 | −6.9 | −0.1 | 4330 | 1 | 780 |
| Example 62 | 65Co—10Cr—17Pt—8SiO₂ | 15 | −6.0 | −0.3 | 4155 | 1 | 975 |
| Example 63 | 65Co—10Cr—17Pt—8SiO₂ | 15 | −6.2 | −0.1 | 4510 | 1 | 1010 |
| Example 64 | 65Co—10Cr—17Pt—8SiO₂ | 15 | −6.4 | −0.1 | 4555 | 1 | 1315 |
| Example 65 | 65Co—10Cr—17Pt—8SiO₂ | 15 | −6.1 | −0.2 | 4515 | 1 | 1115 |
| Example 66 | 65Co—10Cr—17Pt—8SiO₂ | 15 | −6.4 | −0.1 | 4370 | 1 | 1095 |
| Example 67 | 65Co—10Cr—17Pt—8SiO₂ | 15 | −7.1 | −0.2 | 4440 | 1 | 1030 |
| Example 68 | 65Co—10Cr—17Pt—8SiO₂ | 8 | −5.3 | −0.2 | 3750 | 1 | 650 |
| Example 69 | 65Co—10Cr—17Pt—8SiO₂ | 20 | −5.7 | −0.1 | 5150 | 1 | 1550 |
| Example 70 | 67Co—10Cr—17Pt—6SiO₂ | 15 | −5.4 | −0.1 | 4500 | 1 | 1150 |
| Example 71 | 68Co—10Cr—14Pt—8SiO₂ | 15 | −5.7 | −0.1 | 3765 | 1 | 580 |
| Example 72 | 69Co—10Cr—13Pt—8SiO₂ | 15 | −5.2 | −0.2 | 3390 | 0.98 | 300 |
| Example 73 | 65Co—10Cr—17Pt—8Cr₂O₃ | 15 | −5.9 | −0.1 | 4680 | 1 | 1220 |
| Example 74 | 65Co—10Cr—17Pt—8Al₂O₃ | 15 | −5.5 | −0.1 | 4280 | 1 | 890 |
| Example 75 | 65Co—10Cr—17Pt—8CoO | 15 | −5.4 | −0.1 | 4400 | 1 | 1000 |
| Example 76 | 65Co—10Cr—17Pt—8Ta₂O₃ | 15 | −5.9 | −0.1 | 4880 | 1 | 1250 |
| Example 77 | 75Co—17Pt—8SiO₂ | 10 | −5.9 | −0.1 | 4950 | 1 | 1800 |

As shown in Table 9, the Examples in which a material that included an oxide was used in the first undercoat film 3, the second undercoat film 4, and the perpendicular magnetic recording film 5 showed superior read/write properties.

### EXAMPLE 78

A cleaned glass substrate 1 (Ohara Co. of JAPAN, external diameter 2.5 inches) was accommodated in the film formation chamber of a DC magnetron sputter apparatus (ANELVA of JAPAN, C-3010). After air was expelled from the film formation chamber until an ultimate vacuum of 1×10⁻⁵ Pa was attained, a soft magnetic undercoat film 2 having a thickness of 180 nm was formed on the substrate 1 using a sputtering method using a target consisting of 89Co-4Zr-7Nb (Co content of 89 at % , a Zr content of 4 at %, and an Nb content of 7 at % ). It was confirmed by using a vibrating sample magnetometer (VSM) that the product of the saturation magnetic flux Bs and the film thickness t, that is, B·t, of this film was 200T·nm.

Next, at 240° C., the undercoat film 23 having a thickness of 5 nm was formed on the soft magnetic undercoat film 2 described above by using a 75Pt-25C (Pt content of 75 at % and a C content of 25 at % ) target. At this point in time, the crystal particles of the surface of the undercoat film 23 were observed using TEM, and found to have an average diameter of 8 nm.

On the undercoat film 23, the intermediate film 24 having a thickness of 2 nm was formed by using a Ru target, and the perpendicular magnetic recording film 5 having a thickness of 20 nm was formed by using a 64Co-17Cr-17Pt-2B (Co content at 64 at % , Cr content at 17 at % , Pt content at 17 at % and B content at 2 at % ) target. Note that in the sputtering step described above, argon was used as the processing gas for film formation, and the film was formed under a pressure of 0.6 Pa.

Next, a protective film 6 having a thickness of 5 nm was formed by using a CVD method.

Next, a lubricating film 7 consisting or a perfluoropolyether was formed by using a dipping method, and a magnetic recording medium was obtained.

### COMPARATIVE EXAMPLES 6 TO 8

Except for forming the undercoat film 23 by using targets consisting of Pt. Ru, or C, the magnetic recording media were formed according to Example 78. The compositions of these magnetic recording media are shown in Table 10.

The read/write properties of the magnetic recording media in these Examples and Comparative Examples were evaluated. The evaluation of the read/write properties was carried out by using a read/write analyzer RWA1632 and a spin stand S1701MP manufactured by GIZIK Co. (USA).

In the evaluation of the read/write properties, a magnetic head using a single pole electrode in the write portion and using a GMR element in the read back portion was employed, and the recording frequency conditions were measured as a track recording density of 600 kFCI.

In the evaluation of the thermal fluctuation properties, the spin stand described above and the magnetic head described above were used, and after writing at a track recording density of 50 kFCI at a temperature of 70° C., the rate of decrease (%/decade) of the output with respect to the read back output after writing 1 second was calculated based on (S-Sₒ)×100/(S₀×3). In this equation, Sₒ indicates the read back output after the passage of 1 second after writing the signal on the magnetic recording medium, and S indicates the read back output after 1000 seconds. The results of the test are shown in Table 10.

TABLE 10

| | Soft magnetic | | | | | |
|---|---|---|---|---|---|---|
| | undercoat film | | Undercoat film | | Intermediate film | |
| | | Bs · t | Composition | | Composition | |
| | Composition | (T · nm) | (at %) | Thickness (nm) | (at %) | Thickness (nm) |
| Example 78 | CoZrNb | 200 | 75Pt—25C | 5 | Ru | 2 |
| Comparative | CoZrNb | 200 | Pt | 5 | Ru | 2 |
| Example 6 | | | | | | |
| Comparative | CoZrNb | 200 | Ru | 5 | Ru | 2 |
| Example 7 | | | | | | |
| Comparative | CoZrNb | 200 | C | 5 | Ru | 2 |
| Example 8 | | | | | | |

| | Perpendicular magnetic | | Read/write | Thermal | | | |
|---|---|---|---|---|---|---|---|
| | recording film | | properties | stability | Magnetic properties | | |
| | Composition | Thickness | error rate | Properties | Hc | | -Hn |
| | (at %) | (nm) | (10^{x}) | (%/decade) | (Oe) | Mr/Ms | (Oe) |
| Example 78 | 64Co—17Cr—17Pt—2B | 20 | −5.8 | −0.2 | 4535 | 1.00 | 1050 |
| Comparative | 64Co—17Cr—17Pt—2B | 20 | −4.0 | −0.2 | 4480 | 1.00 | 1100 |
| Example 6 | | | | | | | |
| Comparative | 64Co—17Cr—17Pt—2B | 20 | −3.1 | −2.1 | 4250 | 0.80 | −200 |
| Example 7 | | | | | | | |
| Comparative | 64Co—17Cr—17Pt—2B | 20 | −2.5 | −2.8 | 3550 | 0.78 | −450 |
| Example 8 | | | | | | | |

As shown in Table 10, the Examples in which the undercoat film 23 consists of 75Pt-25C shows superior read/write properties compared to the Comparative Examples.

### EXAMPLES 79 TO 87

Except for the compositions of the undercoat film 23 shown in Table 11, the magnetic recording media were fabricated according to Example 78.

The read/write properties of the magnetic recording media in these Examples were evaluated. The results of the tests are shown in Table 11.

TABLE 11

| | Soft magnetic | | | | | |
|---|---|---|---|---|---|---|
| | undercoat film | | Undercoat film | | Intermediate film | |
| | | Bs · t | Composition | Thickness | Composition | Thickness |
| | Composition | (T · nm) | (at %) | (nm) | (at %) | (nm) |
| Example 78 | CoZrNb | 200 | 75Pt—25C | 5 | Ru | 2 |
| Example 79 | CoZrNb | 200 | 98Pt—2C | 5 | Ru | 2 |
| Example 80 | CoZrNb | 200 | 95Pt—5C | 5 | Ru | 2 |
| Example 81 | CoZrNb | 200 | 70Pt—30C | 5 | Ru | 2 |
| Example 82 | CoZrNb | 200 | 60Pt—40C | 5 | Ru | 2 |
| Example 83 | CoZrNb | 200 | 50Pt—50C | 5 | Ru | 2 |
| Example 84 | CoZrNb | 200 | 50Pt—25Fe—25C | 5 | Ru | 2 |
| Example 85 | CoZrNb | 200 | 50Pt—25Ni—25C | 5 | Ru | 2 |
| Example 86 | CoZrNb | 200 | 50Pt—25Co—25C | 5 | Ru | 2 |
| Example 87 | CoZrNb | 200 | 50Pt—25Cr—25C | 5 | Ru | 2 |

| | Perpendicular magnetic | | Read/write | Thermal | Magnetic | | |
|---|---|---|---|---|---|---|---|
| | recording film | | properties | stability | properties | | |
| | Composition | Thickness | error rate | Properties | Hc | Mr/ | -Hn |
| | (at %) | (nm) | (10^{x}) | (%/decade) | (Oe) | Ms | (Oe) |
| Example 78 | 64Co—17Cr—17Pt—2B | 20 | −5.8 | −0.2 | 4535 | 1.00 | 1050 |
| Example 79 | 64Co—17Cr—17Pt—2B | 20 | −4.5 | −0.2 | 4500 | 1.00 | 1100 |
| Example 80 | 64Co—17Cr—17Pt—2B | 20 | −5.1 | −0.2 | 4550 | 0.99 | 1000 |
| Example 81 | 64Co—17Cr—17Pt—2B | 20 | −5.2 | −0.2 | 4385 | 1.00 | 950 |
| Example 82 | 64Co—17Cr—17Pt—2B | 20 | −4.7 | −0.4 | 4440 | 0.97 | 800 |
| Example 83 | 64Co—17Cr—17Pt—2B | 20 | −4.3 | −0.5 | 4200 | 0.95 | 400 |
| Example 84 | 64Co—17Cr—17Pt—2B | 20 | −5.7 | −0.1 | 4630 | 1.00 | 950 |
| Example 85 | 64Co—17Cr—17Pt—2B | 20 | −6.0 | −0.2 | 4800 | 1.00 | 1100 |
| Example 86 | 64Co—17Cr—17Pt—2B | 20 | −5.9 | −0.2 | 4500 | 1.00 | 1000 |
| Example 87 | 64Co—17Cr—17Pt—2B | 20 | −5.6 | −0.2 | 4535 | 0.99 | 950 |

As shown in Table 11, the Examples in which the undercoat film 23 included at least Pt or C, superior read/write properties were shown. In particular, the Examples in which the C content of the undercoat film 23 was equal to or greater than 1 at % and equal to or less than 40 at % (in particular, equal to or greater than 5 at % and equal to or less than 30 at % ) showed superior properties.

### EXAMPLES 88 TO 92

Except for the thickness of the undercoat film 23 shown in Table 12, the magnetic recording media were fabricated according to Example 78.

The read/write properties of the magnetic recording media in these Examples were evaluated. The results of the tests are shown in Table 12.

TABLE 12

| | Soft magnetic | | | | | |
|---|---|---|---|---|---|---|
| | undercoat film | | Undercoat film | | Intermediate film | |
| | | Bs · t | Composition | | Composition | |
| | Composition | (T · nm) | (at %) | Thickness (nm) | (at %) | Thickness (nm) |
| Example 78 | CoZrNb | 200 | 75Pt—25C | 5 | Ru | 2 |
| Example 88 | CoZrNb | 200 | 75Pt—25C | 0.5 | Ru | 2 |
| Example 89 | CoZrNb | 200 | 75Pt—25C | 1 | Ru | 2 |
| Example 90 | CoZrNb | 200 | 75Pt—25C | 10 | Ru | 2 |
| Example 91 | CoZrNb | 200 | 75Pt—25C | 15 | Ru | 2 |
| Example 92 | CoZrNb | 200 | 75Pt—25C | 25 | Ru | 2 |

| | Perpendicular magnetic | | Read/write | Thermal | | | |
|---|---|---|---|---|---|---|---|
| | recording film | | properties | stability | Magnetic properties | | |
| | Composition | Thickness | error rate | Properties | Hc | | -Hn |
| | (at %) | (nm) | (10^{x}) | (%/decade) | (Oe) | Mr/Ms | (Oe) |
| Example 78 | 64Co—17Cr—17Pt—2B | 20 | −5.8 | −0.2 | 4535 | 1.00 | 1050 |
| Example 88 | 64Co—17Cr—17Pt—2B | 20 | −4.4 | −0.7 | 4100 | 0.90 | 200 |
| Example 89 | 64Co—17Cr—17Pt—2B | 20 | −4.9 | −0.5 | 4300 | 0.93 | 350 |
| Example 90 | 64Co—17Cr—17Pt—2B | 20 | −5.4 | −0.2 | 4610 | 1.00 | 1000 |
| Example 91 | 64Co—17Cr—17Pt—2B | 20 | −4.6 | −0.1 | 4610 | 0.97 | 1000 |
| Example 92 | 64Co—17Cr—17Pt—2B | 20 | −4.1 | −0.2 | 4465 | 0.97 | 750 |

As shown in Table 12, the Examples in which the thickness of the undercoat film 23 was equal to or greater than 0.5 nm and equal to or less than 15 nm (in particular 1 to 10 nm) showed superior read/write properties.

### EXAMPLES 93 TO 97

Except for the temperature during formation of the undercoat film 23 shown in Table 13, the magnetic recording media were fabricated according to Example 78.

The read/write properties of the magnetic recording media in these Examples were evaluated. The results of the tests are shown in Table 13.

TABLE 13

| | Soft magnetic | | Undercoat film | | | | |
|---|---|---|---|---|---|---|---|
| | undercoat film | | | | Formation | Intermediate film | |
| | | Bs · t | Composition | Thickness | temperature | Composition | Thickness |
| | Composition | (T · nm) | (at %) | (nm) | (° C.) | (at %) | (nm) |
| Example 78 | CoZrNb | 200 | 75Pt—25C | 5 | 240 | Ru | 2 |
| Example 93 | CoZrNb | 200 | 98Pt—2C | 5 | No beating | Ru | 2 |
| Example 94 | CoZrNb | 200 | 95Pt—5C | 5 | 100 | Ru | 2 |
| Example 95 | CoZrNb | 200 | 70Pt—30C | 5 | 150 | Ru | 2 |
| Example 96 | CoZrNb | 200 | 60Pt—40C | 5 | 400 | Ru | 2 |
| Example 97 | CoZrNb | 200 | 50Pt—50C | 5 | 500 | Ru | 2 |

| | Perpendicular magnetic | | Read/write | Thermal | | | |
|---|---|---|---|---|---|---|---|
| | recording film | | properties | stability | Magnetic properties | | |
| | Composition | Thickness | error rate | Properties | Hc | | -Hn |
| | (at %) | (nm) | (10^{x}) | (%/decade) | (Oe) | Mr/Ms | (Oe) |
| Example 78 | 64Co—17Cr—17Pt—2B | 20 | −5.8 | −0.2 | 4535 | 1.00 | 1050 |
| Example 93 | 64Co—17Cr—17Pt—2B | 20 | −5.0 | −0.1 | 4555 | 1.00 | 1100 |
| Example 94 | 64Co—17Cr—17Pt—2B | 20 | −5.2 | −0.2 | 4435 | 0.99 | 1000 |
| Example 95 | 64Co—17Cr—17Pt—2B | 20 | −5.5 | −0.2 | 4385 | 1.00 | 950 |
| Example 96 | 64Co—17Cr—17Pt—2B | 20 | −5.2 | −0.2 | 4440 | 0.97 | 550 |
| Example 97 | 64Co—17Cr—17Pt—2B | 20 | −4.3 | −0.1 | 3850 | 0.91 | 150 |

As shown in Table 13, the Examples for which the temperature during the formation of the undercoat film 23 was from 150 to 400° C. showed superior read/write properties.

### EXAMPLES 98 TO 104

Except for the material and thickness of the soft magnetic undercoat film 2 shown in FIG. 14, the magnetic recording media were fabricated according to Example 78.

### EXAMPLES 105 TO 107

Except for providing the seed film 8 between the soft magnetic undercoat film 2 and the undercoat film 23, the magnetic recording media were fabricated according to Example 78.

The read/write properties of the magnetic recording media in these Examples were evaluated. The results of the tests are shown in Table 14.

TABLE 14

| | Soft magnetic | | | | Undercoat | | Intermediate | |
|---|---|---|---|---|---|---|---|---|
| | undercoat film | | Seed film | | film | | film | |
| | | Bs · t | Composition | Thickness | Composition | Thickness | Composition | Thickness |
| | Composition | (T · nm) | (at %) | (nm) | (at %) | (nm) | (at %) | (nm) |
| Example 78 | CoZrNb | 200 | — | — | 75Pt—25C | 5 | Ru | 2 |
| Example 98 | FeCoB | 200 | — | — | 75Pt—25C | 5 | Ru | 2 |
| Example 99 | FeTaC | 200 | — | — | 75Pt—25C | 5 | Ru | 2 |
| Example 100 | CoNiP | 200 | — | — | 75Pt—25C | 5 | Ru | 2 |
| Example 101 | FeCoNiP | 200 | — | — | 75Pt—25C | 5 | Ru | 2 |
| Example 102 | FeAlO | 200 | — | — | 75Pt—25C | 5 | Ru | 2 |
| Example 103 | CoZrNb | 60 | — | — | 75Pt—25C | 5 | Ru | 2 |
| Example 104 | CoZrNb | 400 | — | — | 75Pt—25C | 5 | Ru | 2 |
| Example 105 | CoZrNb | 200 | NiTa | 10 | 75Pt—25C | 5 | Ru | 2 |
| Example 106 | CoZrNb | 200 | CoZr | 10 | 75Pt—25C | 5 | Ru | 2 |
| Example 107 | CoZrNb | 200 | FeTaN | 10 | 75Pt—25C | 5 | Ru | 2 |

| | Perpendicular magnetic | | Read/write | Thermal | | | |
|---|---|---|---|---|---|---|---|
| | recordingfilm | | properties | stability | Magnetic properties | | |
| | Composition | Thickness | error rate | Properties | Hc | | -Hn |
| | (at %) | (nm) | (10^{x}) | (%/decade) | (Oe) | Mr/Ms | (Oe) |
| Example 78 | 64Co—17Cr—17Pt—2B | 20 | −5.8 | −0.2 | 4535 | 1.00 | 1050 |
| Example 98 | 64Co—17Cr—17Pt—2B | 20 | −5.6 | −0.2 | 4625 | 1.00 | 1100 |
| Example 99 | 64Co—17Cr—17Pt—2B | 20 | −5.4 | −0.2 | 4400 | 0.99 | 1000 |
| Example 100 | 64Co—17Cr—17Pt—2B | 20 | −5.9 | −0.2 | 4515 | 1.00 | 950 |
| Example 101 | 64Co—17Cr—17Pt—2B | 20 | −6.0 | −0.1 | 4445 | 1.00 | 1200 |
| Example 102 | 64Co—17Cr—17Pt—2B | 20 | −5.4 | −0.3 | 4390 | 1.00 | 1000 |
| Example 103 | 64Co—17Cr—17Pt—2B | 20 | −4.9 | −0.1 | 4550 | 1.00 | 950 |
| Example 104 | 64Co—17Cr—17Pt—2B | 20 | −6.0 | −0.2 | 4420 | 1.00 | 1100 |
| Example 105 | 64Co—17Cr—17Pt—2B | 20 | −6.1 | −0.2 | 4500 | 1.00 | 1000 |
| Example 106 | 64Co—17Cr—17Pt—2B | 20 | −6.0 | −0.2 | 4545 | 0.99 | 950 |
| Example 107 | 64Co—17Cr—17Pt—2B | 20 | −6.2 | −0.1 | 4560 | 1.00 | 950 |

As shown in Table 14, the Examples showed superior read/write properties. In particular, superior read/write properties were obtained in the Examples providing the seed film 8 obtained.

### EXAMPLES 108 TO 116

Except for the material and thickness of the intermediate film 24 and the perpendicular magnetic recording film 5 shown in Table 15, the magnetic recording media were fabricated according to Example 78.

The read/write properties of the magnetic recording media in these Examples were evaluated. The results are shown in Table 15.

Note that in the Table, Ru/CoCr indicates having a two-layer structure in which the intermediate film 24 provides a second layer consisting of CoCr on the first layer that consists of Ru. The thickness of the intermediate films 24 are all 2 nm, and this is denoted by 2/2.

TABLE 15

| | Soft magnetic | | Undercoat film | | Intermediate film | |
|---|---|---|---|---|---|---|
| | undercoat film | | Composition | | Composition | |
| | Composition | Bs · t (T · nm) | (at %) | Thickness (nm) | (at %) | Thickness (nm) |
| Example 78 | CoZrNb | 200 | 75Pt—25C | 5 | Ru | 2 |
| Example 108 | CoZrNb | 200 | 75Pt—25C | 5 | — | — |
| Example 109 | CoZrNb | 200 | 75Pt—25C | 5 | Ru | 10 |
| Example 110 | CoZrNb | 200 | 75Pt—25C | 5 | RuW | 2 |
| Example 110 | CoZrNb | 200 | 75Pt—25C | 5 | CoCr | 2 |
| Example 112 | CoZrNb | 200 | 75Pt—25C | 5 | Ru/CoCr | 2/2 |
| Example 113 | CoZrNb | 200 | 75Pt—25C | 5 | Ru | 2 |
| Example 114 | CoZrNb | 200 | 75Pt—25C | 5 | Ru | 2 |
| Example 115 | CoZrNb | 200 | 75Pt—25C | 5 | Ru | 2 |
| Example 116 | CoZrNb | 200 | 75Pt—25C | 5 | Ru | 2 |

| | Perpendicular magnetic | | Read/write | Thermal | | | |
|---|---|---|---|---|---|---|---|
| | recording film | | properties | stability | Magnetic properties | | |
| | Composition | Thickness | error rate | Properties | Hc | | -Hn |
| | (at %) | (nm) | (10^{x}) | (%/decade) | (Oe) | Mr/Ms | (Oe) |
| Example 78 | 64Co—17Cr—17Pt—2B | 20 | −5.8 | −0.2 | 4535 | 1.00 | 1050 |
| Example 108 | 64Co—17Cr—17Pt—2B | 20 | −4.9 | −0.1 | 4500 | 1.00 | 1100 |
| Example 109 | 64Co—17Cr—17Pt—2B | 20 | −5.2 | −0.2 | 4700 | 0.99 | 900 |
| Example 110 | 64Co—17Cr—17Pt—2B | 20 | −5.7 | −0.2 | 4385 | 1.00 | 950 |
| Example 110 | 64Co—17Cr—17Pt—2B | 20 | −5.8 | −0.4 | 4565 | 1.00 | 1000 |
| Example 112 | 64Co—17Cr—17Pt—2B | 20 | −6.1 | −0.5 | 4765 | 0.95 | 1200 |
| Example 113 | 61Co—22Cr—17Pt | 20 | −5.9 | −0.4 | 4630 | 0.91 | 400 |
| Example 114 | 67Co—10Cr—17Pt—6SiO₂ | 20 | −5.1 | −0.1 | 4800 | 1.00 | 1200 |
| Example 115 | 64Co—17Cr—17Pt—2B | 10 | −5.5 | −0.4 | 3955 | 0.91 | 450 |
| Example 116 | 64Co—17Cr—17Pt—2B | 30 | −5.1 | −0.1 | 4300 | 0.99 | 850 |

As shown in Table 15, the Examples showed superior read/write properties.

### EXAMPLE 117

Except for forming the undercoat film 23 as follows, the magnetic recording medium was fabricated according to Example 78.

Specifically, the undercoat film 23 having a thickness of 5 nm was formed on a soft magnetic undercoat film 2 by using a 75Pd-25C (Pd content at 75 at % and C content at 25 at % ) target. At this point in time, the crystal particles of the surface of the undercoat film 23 were observed using TEM, and found to have an average diameter of 8.3 nm.

The read/write properties of the magnetic recording media in these Examples were evaluated. The results of the tests are shown in Table 16.

### COMPARATIVE EXAMPLE 9

Except for forming the undercoat film 23 using the target consisting of Pd, the magnetic recording media were fabricated according to Example 117. The read/write properties of this magnetic recording medium were evaluated. The results of the tests are shown in Table 16.

### EXAMPLES 118 TO 124

Except for the composition and thickness of the undercoat film 23 shown in Table 16, the magnetic recording media were fabricated according to Example 117. The read/write properties of the magnetic recording media in these Examples were evaluated. The results of the tests are shown in Table 16.

TABLE 16

| | Soft magnetic | | | | | |
|---|---|---|---|---|---|---|
| | undercoat film | | Undercoat film | | Intermediate film | |
| | | Bs · t | Composition | Thickness | Composition | Thickness |
| | composition | (T · nm) | (at %) | (nm) | (at %) | (nm) |
| Example 117 | CoZrNb | 200 | 75Pd—25C | 5 | Ru | 2 |
| Example 118 | CoZrNb | 200 | 75Pd—25C | 1 | Ru | 2 |
| Example 119 | CoZrNb | 200 | 75Pd—25C | 20 | Ru | 2 |
| Example 120 | CoZrNb | 200 | 95Pd—5C | 5 | Ru | 2 |
| Example 121 | CoZrNb | 200 | 60Pd—40C | 5 | Ru | 2 |
| Example 122 | CoZrNb | 200 | 50Pd—25Fe—25C | 5 | Ru | 2 |
| Example 123 | CoZrNb | 200 | 50Pd—25Co—25C | 5 | Ru | 2 |
| Example 124 | CoZrNb | 200 | 50Pd—25Cr—25C | 5 | Ru | 2 |
| Comparative | CoZrNb | 200 | Ru | 5 | Ru | 2 |
| Example 7 | | | | | | |
| Comparative | CoZrNb | 200 | C | 5 | Ru | 2 |
| Example 8 | | | | | | |
| Comparative | CoZrNb | 200 | Pd | 5 | Ru | 2 |
| Example 9 | | | | | | |

| | Perpendicular magnetic | | Read/write | Thermal | Magnetic | | |
|---|---|---|---|---|---|---|---|
| | recording film | | properties | stability | properties | | |
| | Composition | Thickness | error rate | Properties | Hc | Mr/ | -Hn |
| | (at %) | (nm) | (10^{x}) | (%/decade) | (Oe) | Ms | (Oe) |
| Example 117 | 64Co—17Cr—17Pt—2B | 20 | −5.5 | −0.2 | 4560 | 1 | 950 |
| Example 118 | 64Co—17Cr—17Pt—2B | 20 | −4.8 | −0.5 | 4215 | 0.95 | 300 |
| Example 119 | 64Co—17Cr—17Pt—2B | 20 | −4.4 | −0.1 | 4780 | 1 | 900 |
| Example 120 | 64Co—17Cr—17Pt—2B | 20 | −5.2 | −0.2 | 4490 | 1 | 900 |
| Example 121 | 64Co—17Cr—17Pt—2B | 20 | −4.7 | −0.5 | 4370 | 0.94 | 700 |
| Example 122 | 64Co—17Cr—17Pt—2B | 20 | −5.8 | −0.1 | 4600 | 1 | 1000 |
| Example 123 | 64Co—17Cr—17Pt—2B | 20 | −6.2 | −0.2 | 4610 | 1 | 1050 |
| Example 124 | 64Co—17Cr—17Pt—2B | 20 | −5.7 | −0.2 | 5030 | 0.97 | 950 |
| Comparative | 64Co—17Cr—17Pt—2B | 20 | −3.1 | −2.1 | 4250 | 0.8 | −200 |
| Example 7 | | | | | | | |
| Comparative | 64Co—17Cr—17Pt—2B | 20 | −2.5 | −2.8 | 3550 | 0.78 | −450 |
| Example 8 | | | | | | | |
| Comparative | 64Co—17Cr—17Pt—2B | 20 | −3.7 | −0.7 | 4300 | 0.98 | 700 |
| Example 9 | | | | | | | |

As shown in Table 16, Examples in which the undercoat film 23 included at least Pd and C showed superior read/write properties.

### EXAMPLES 125 TO 135

Magnetic recording media were fabricated in which the material and the thickness of the intermediate film 24 and the perpendicular magnetic recording film 5 were as shown in Table 17. The other conditions were according to Example 78. The read/write properties of the magnetic recording media in these Examples were evaluated. The results of the tests are shown in Table 17.

TABLE 17

| | Soft magnetic | | Undercoat film | | Intermediate film | |
|---|---|---|---|---|---|---|
| | undercoat film | | Composition | | Composition | |
| | Composition | Bs · t (T · nm) | (at %) | Thickness (nm) | (at %) | Thickness (nm) |
| Example 125 | CoZrNb | 200 | 75Pt—25C | 5 | Ru | 15 |
| Example 126 | CoZrNb | 200 | 75Pt—25C | 5 | Ru | 15 |
| Example 127 | CoZrNb | 200 | 75Pt—25C | 5 | Ru | 15 |
| Example 128 | CoZrNb | 200 | 75Pt—25C | 5 | Ru | 15 |
| Example 129 | CoZrNb | 200 | 75Pt—25C | 5 | Ru | 15 |
| Example 130 | CoZrNb | 200 | 75Pt—25C | 5 | Ru | 15 |
| Example 131 | CoZrNb | 200 | 75Pt—25C | 5 | Ru | 15 |
| Example 132 | CoZrNb | 200 | 75Pt—25C | 5 | Ru | 15 |
| Example 133 | CoZrNb | 200 | 75Pt—25C | 5 | Ru | 15 |
| Example 134 | CoZrNb | 200 | 75Pt—25C | 5 | Ru | 15 |
| Example 135 | CoZrNb | 200 | 75Pt—25C | 5 | Ru | 15 |

| | Perpendicular magnetic | | Read/write | Thermal | | | |
|---|---|---|---|---|---|---|---|
| | recording film | | properties | stability | Magnetic properties | | |
| | Composition | Thickness | error rate | Properties | Hc | | -Hn |
| | (at %) | (nm) | (10^{x}) | (%/decade) | (Oe) | Mr/Ms | (Oe) |
| Example 125 | 65Co—10Cr—17Pt—8SiO₂ | 8 | −5.3 | −0.2 | 3750 | 1 | 650 |
| Example 126 | 65Co—10Cr—17Pt—8SiO₂ | 20 | −5.7 | −0.1 | 5150 | 1 | 1550 |
| Example 127 | 67Co—10Cr—17Pt—6SiO₂ | 15 | −5.4 | −0.1 | 4500 | 1 | 1150 |
| Example 128 | 68Co—10Cr—14Pt—8SiO₂ | 15 | −5.7 | −0.1 | 3765 | 1 | 580 |
| Example 129 | 69Co—10Cr—13Pt—8SiO₂ | 15 | −5.2 | −0.2 | 3390 | 0.98 | 300 |
| Example 130 | 65Co—10Cr—17Pt—8Cr₂O₃ | 15 | −5.9 | −0.1 | 4680 | 1 | 1220 |
| Example 131 | 65Co—10Cr—17Pt—8Al₂O₃ | 15 | −5.5 | −0.1 | 4280 | 1 | 890 |
| Example 132 | 65Co—10Cr—17Pt—8CoO | 15 | −5.4 | −0.1 | 4400 | 1 | 1000 |
| Example 133 | 65Co—10Cr—17Pt—8Ta₂O₅ | 15 | −5.9 | −0.1 | 4880 | 1 | 1250 |
| Example 134 | 65Co—10Cr—17Pt—8ZnO₂ | 15 | −5.8 | −0.1 | 4750 | 1 | 1150 |
| Example 135 | 75Co—17Pt—8SiO₂ | 10 | −5.8 | −0.1 | 5100 | 1 | 1900 |

As shown in Table 17, the Examples in which the perpendicular magnetic recording film S included an oxide showed superior read/write properties.

### INDUSTRIAL APPLICABILITY

In the magnetic recording media of the present invention, at least a soft magnetic undercoat film, a first undercoat film, a second undercoat film, a perpendicular magnetic recording film, and a protective film are provided on a non-magnetic substrate; the first undercoat film consists of Pt, Pd, or an alloy including at least one among them; and the second undercoat film consists of Ru or an Ru alloy. Thereby, it is possible to improve the read/write properties and the thermal stability.

In addition, a soft magnetic undercoat film, an undercoat film that controls the orientation and crystal diameter of the film directly above, a perpendicular magnetic recording film in which the easy magnetization axis is generally oriented perpendicular to the substrate, and a protective film are provided; the undercoat film consists of an alloy that includes at least Pt and C or an alloy that includes at least Pd and C are provided on a non-magnetic substrate. Thereby, it is possible to improve the read/write properties and the thermal stability.

1. A magnetic recording medium providing on a non-magnetic substrate at least a soft magnetic undercoat film, a first undercoat film that controls the orientation of the film directly above, a second undercoat film, and a perpendicular magnetic recording film whose easy magnetization axis is generally oriented perpendicular to the substrate, and a protective film, wherein
said first undercoat film consists of Pt, Pd, or an alloy including at least one among these and the second undercoat film consists of Ru or an Ru alloy.

2. A magnetic recording medium according to claim 1 wherein the thickness of the first undercoat film is equal to or greater than 0.5 nm and equal to or less than 10 nm.

3. A magnetic recording medium according to claim 1 wherein the thickness of the second undercoat film is equal to or greater than 0.5 nm and equal to or less than 10 nm.

4. A magnetic recording medium according to claim 1 wherein the first undercoat film has a fcc structure.

5. A magnetic recording medium according to claim 1 wherein a seed film having an amorphous structure or a microcrystalline structure is provided between the soft magnetic undercoat film and the first undercoat film.

6. A magnetic recording medium according to claim 1 wherein the first undercoat film includes C.

7. A magnetic recording medium according to claim 1 wherein the perpendicular magnetic recording film consists of a material that includes at least Co and Pt, and whose negative nucleation field (−Hn) is equal to or greater than 0.

8. A magnetic recording medium according to claim 1 wherein the first undercoat film having a granular structure consists of Pt or Pd, and an oxide.

9. A magnetic recording medium according to claim 8 wherein the oxide is selected from SiO₂, Al₂O₃, Cr₂O₃, CoO, and Ta₂O₅.

10. A magnetic recording medium according to claim 1 wherein the second undercoat film has a granular structure consisting of Ru or an Ru alloy, and an oxide.

11. A magnetic recording medium according to claim 10 wherein the oxide is selected form SiO₂, Al₂O₃, Cr₂O₃, CoO, and Ta₂O₅.

12. A magnetic recording medium according to claim 1 wherein the perpendicular magnetic recording film consisting of a material having at least one of SiO₂, Al₂O₃, ZrO₂, Cr₂O₃, and Ta₂O₅ added to a CoPt alloy or an CoCrPt alloy.

13. A fabricating method for a magnetic recording medium comprising the steps of:
forming in sequence on a non-magnetic substrate at least a soft magnetic undercoat film, a first undercoat film that controls the orientation of the film directly above, a second undercoat film, a perpendicular magnetic recording film whose easy magnetization axis is generally oriented perpendicular to the substrate, and a protective film; and wherein
said first undercoat film consists of Pt, Pd, or an alloy including at least one among these and the second undercoat film consists of Ru or an Ru alloy.

14. A magnetic read/write apparatus providing a magnetic recording medium and a magnetic head that reads and writes data on said magnetic recording medium; wherein
the magnetic head is a single pole head; and
the magnetic recording medium provides on a non-magnetic substrate at least a soft magnetic undercoat film, a first undercoat film that controls the orientation of the film directly above, a second undercoat film, a perpendicular magnetic recording film whose easy magnetization axis is generally oriented perpendicular to the substrate, and a protective film; and said first undercoat film consists of Pt, Pd, or an alloy including at least one among these, and the second undercoat film consists of Ru or an Ru alloy.

15. A magnetic recording medium providing on a non-magnetic substrate at least a soft magnetic undercoat film, an undercoat film that control the orientation and the crystal diameter of the film directly above, a perpendicular magnetic recording film whose easy magnetization axis is generally oriented perpendicular to the substrate, and a protective film; and wherein
said undercoat film consists of an alloy that includes at least Pt and C or an alloy that includes at least Pd and C.

16. A magnetic recording medium according to claim 15 wherein the C content of the undercoat film is equal to or greater than 1 at % and equal to or less than 40 at %.

17. A magnetic recording medium according to claim 15 wherein the C content of the undercoat film is equal to or greater than 5 at % and equal to or less than 30 at %.

18. A magnetic recording medium according to claim 15 wherein the thickness of the undercoat film is equal to or greater than 0.5 nm and equal to or less than 15 nm.

19. A magnetic recording medium according to claim 15 wherein an intermediate film that includes at least one among Ru and Co is provided between the undercoat film and the perpendicular magnetic recording film.

20. A magnetic recording medium according to claim 15 wherein a seed film having an amorphous structure or a microcrystalline structure is provided between the soft magnetic undercoat film and the undercoat film.

21. A magnetic recording medium according to claim 15 wherein the undercoat film consists of one among a Pt—C alloy, Pt—Fe—C alloy, Pt—Ni—C alloy, Pt—Co—C alloy, Pt—Cr—C alloy, Pd—C alloy, Pd—Fe—C alloy, Pd—Ni—C alloy, Pd—Co—C alloy, or Pd—Cr—C alloy.

22. A magnetic recording medium according to claim 15 wherein the average diameter of the crystal particles of the undercoat film is equal to or greater than 5 nm or equal to or less than 12 nm.

23. A magnetic recording medium according to claim 15 wherein the perpendicular magnetic recording film consists of a material that includes at least Co and Pt, and whose negative nucleation field (−Hn) is equal to or greater than 0.

24. A magnetic recording medium according to claim 15 wherein the perpendicular magnetic recording film consists of a material having at least one of SiO₂, Al₂O₃, ZrO₂, Cr₂O₃, and Ta₂O₅ added to a CoPt alloy or a CoCrPt alloy.

25. A fabricating method for a magnetic recording medium comprising the steps of: forming in sequence on a non-magnetic substrate at least a soft magnetic undercoat film, an undercoat film that controls the orientation and the crystal diameter of the film directly above a perpendicular magnetic recording film whose easy magnetization axis is generally oriented perpendicular to the substrate, and a protective film; and
said undercoat film consists of an alloy that includes at least Pt and C or an alloy that includes at least Pd and C.

26. A fabricating method for a magnetic recording medium according to claim 25 wherein the undercoat film is formed at a temperature of 150 to 400° C.

27. A magnetic read/write apparatus providing a magnetic recording medium and a magnetic head that reads and writes data on said magnetic recording medium; wherein
the magnetic head is a single pole head; and
the magnetic recording medium provides on a non-magnetic substrate at least a soft magnetic undercoat film, an undercoat film that controls the orientation and the crystal diameter of the film directly above, a perpendicular magnetic recording film whose easy magnetization axis is generally oriented perpendicular to the substrate, and a protective film; and wherein said undercoat film consists of an alloy that includes at least Pt and C or and alloy that includes at least Pd and C. _
